(19) United States
(12) Patent Application Publication
(10) Pub. No.: US 2025/0380132 A1
(43) Pub. Date: Dec. 11, 2025

(54) AUTHENTICATION METHODS FOR SBA-ENABLED DEVICES

(71) Applicant: INTERDIGITAL PATENT HOLDINGS, INC., Wilmington, DE (US)

(72) Inventors: Mohamad Kenan Al-Hares, Canterbury (GB); Sebastian Robitzsch, London (GB)

(73) Assignee: INTERDIGITAL PATENT HOLDINGS, INC., Wilmington, DE (US)

(21) Appl. No.: 18/876,485

(22) PCT Filed: Jul. 11, 2023
(86) PCT No.: PCT/US2023/027427

§ 371 Date: Dec. 18, 2024

Related U.S. Application Data
(60) Provisional application No. 63/388,116, filed on Jul. 11, 2022.
(60) Provisional application No. 63/390,829, filed on Jul. 20, 2022.

(51) Int. Cl. H04W 12/06; H04L 9/32; H04L 9/40; H04W 12/0431; H04W 12/72

(52) U.S. Cl. CPC H04W 12/06; H04L 9/3271; H04L 63/166; H04W 12/0431; H04W 12/72

(57) ABSTRACT

In an effort to extend Service-Based Architecture to the wireless transmit receive units (WTRUs), there may be systems, devices, and methods that address approaches and techniques to facilitate communication directly with the Core Network Functions without the need to go through the Access and Mobility Function. As part of the upgrade of N1 to utilize HTTP instead of the Non-Access Stratum protocol, there may be techniques and approaches that permit the usage of HTTP semantics.

### CROSS-REFERENCE TO RELATED APPLICATIONS

This application claims the benefit of U.S. Provisional Patent Application No. 63/388, 116, filed Jul. 11, 2022 and U.S. Provisional Patent Application No. 63/390,829, filed Jul. 20, 2022, the contents of which are incorporated herein by reference.

### BACKGROUND

As wireless protocols develop, there is a need to address inefficiencies in different wireless architectures.

### SUMMARY

In an effort to extend Service-Based Architecture to the wireless transmit receive units (WTRUs), there may be systems, devices, and methods that address approaches and techniques to facilitate communication directly with the Core Network Functions without the need to go through the Access and Mobility Function. As part of the upgrade of N1 to utilize HTTP instead of the Non-Access Stratum protocol, there may be techniques and approaches that permit the usage of HTTP semantics.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates an example of a Service-Based Architecture (SBA);

FIG. 3 illustrates an example of an access token-based consumer/producer communication;

FIG. 4 illustrates an example of an authentication initiation messaging exchange;

FIG. 5 illustrates an example of an Extensible Authentication Protocol-Authentication and Key Agreement (EAP-AKA);

FIG. 6 illustrates an example of authentication response messaging that may use an Authentication and Key Agreement (AKA), such as 5G-AKA;

FIG. 7 illustrates an example of an authentication and encryption procedure for client server communication, which may be on the internet;

FIG. 8, which comprises FIG. 8A and FIG. 8B, illustrates an example of a registration/authentication process for untrusted non-3GPP access;

FIG. 9, which comprises FIG. 9A and FIG. 9B and FIG. 9C, illustrates an example of a registration/authentication and PDU session establishment process for trusted non-3GPP access;

FIG. 10 illustrates an example of a system architecture;

FIG. 11 illustrates an example of an authentication for SBA-Enabled WTRUs, such as a 6G standalone authentication for SBA-Enabled WTRUs;

FIG. 12 illustrates an example of a message sequence chart for challenging a WTRU;

FIG. 13 illustrates an example of non-standalone authentication procedures, such as 6G non-standalone authentication procedures for SBI_Enabled 6G WTRUs with a 5G Core;

FIG. 14 illustrates an example of a message sequence chart for challenging a WTRU;

FIG. 15, which comprises FIG. 15A and 15B, illustrates example system architectures;

FIG. 16, which comprises FIG. 16A and FIG. 16B, illustrates an example authentication process for untrusted non-3GPP access networks;

FIG. 17 illustrates an example of a message sequence chart for challenging a WTRU in an untrusted non-3GPP network;

FIG. 18, which comprises FIG. 18A and FIG. 18B, illustrates an example of an authentication for trusted non-3GPP access networks;

FIG. 19 illustrates an example of a message sequence chart for challenging a WTRU in trusted non-3GPP networks; and

FIG. 20 illustrates an example of an authentication process performed by a WTRU.

### DETAILED DESCRIPTION

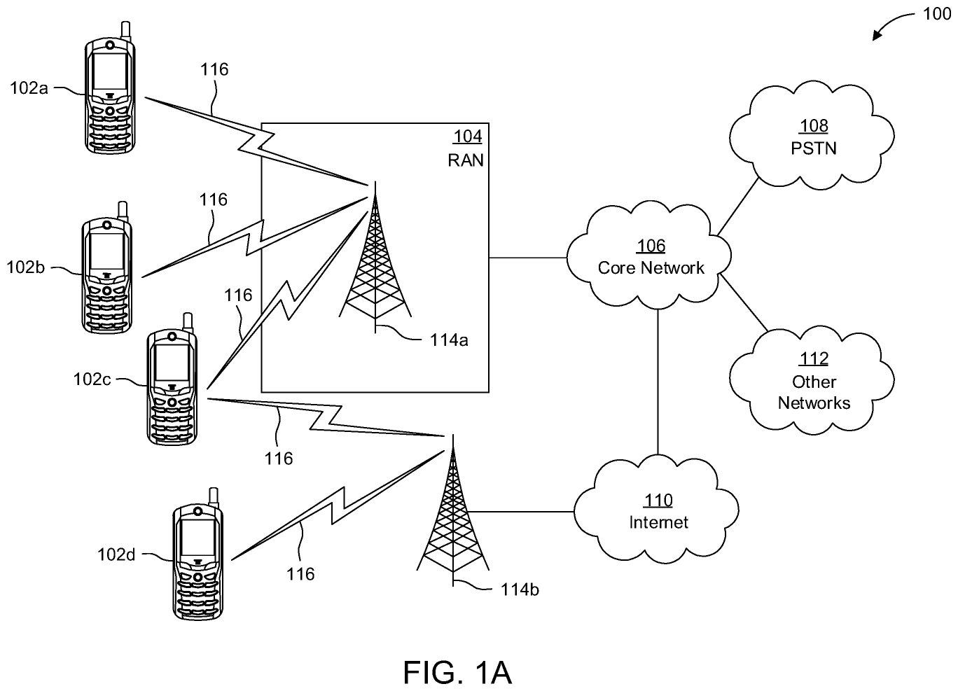

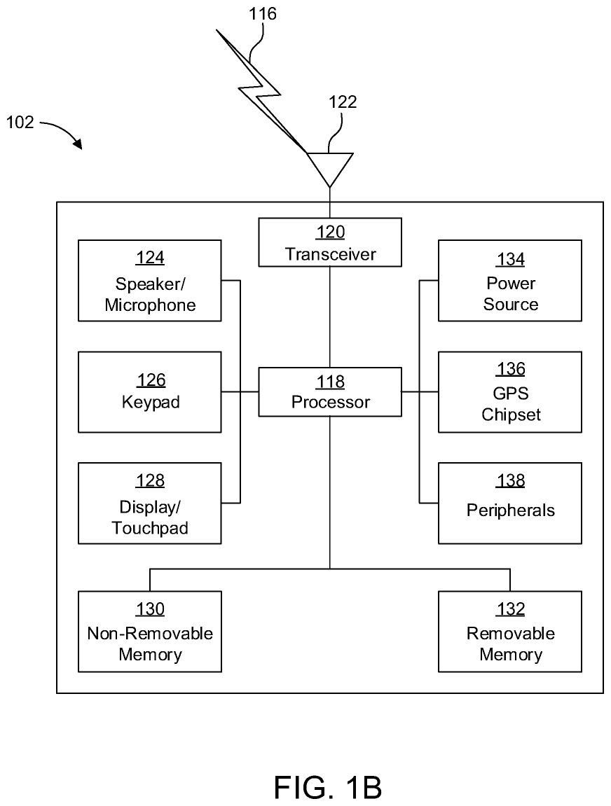

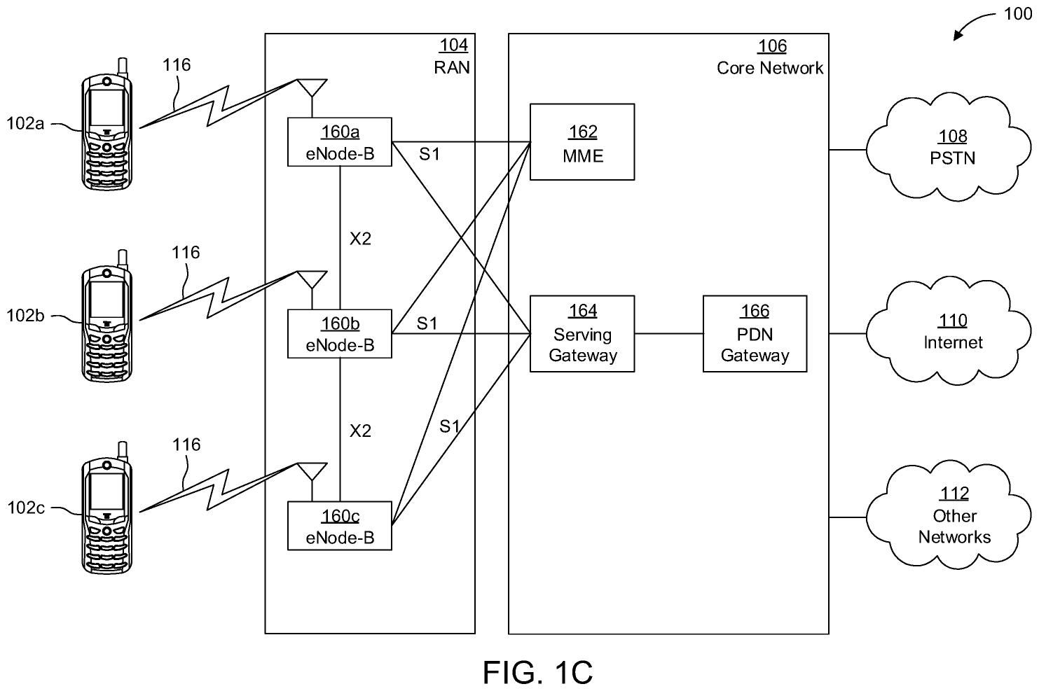

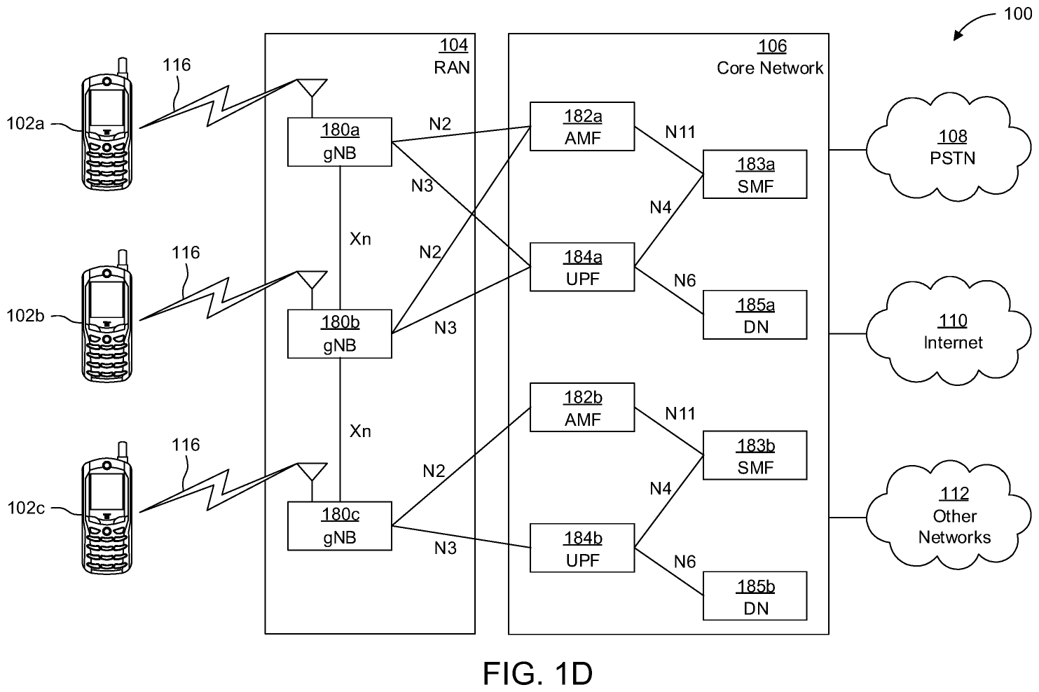

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102μc, —102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VolP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHZ, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHZ, and 20 MHz bandwidths in the TV White Space (TVWS) spectrum, and 802.11ah supports 1 MHZ, 2 MHZ, 4 MHz, 8 MHZ, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Systems, methods, and devices may be further described herein for WTRUs to communicate (e.g., communicate directly) to core network functions for authentication purposes (e.g., without the need to go through the access and mobility function). As part of the upgrade of N1 to utilize HTTP instead of non-access stratum protocol, the WTRU may permit the usage of HTTP semantics.

In some cases, an end-to-end SBA network may perform messaging (e.g., direct messaging) between the WTRU and AUSF for authentication (e.g., as opposed to legacy approaches of going through the AMF). In one or more examples, the WTRU may have an SBI interface that can communicate with core network (CN) NFs (e.g., any CN NFs disclosed herein). The WTRU may act as a producer or a consumer during the authentication process. This may improve energy efficiency of the control plane (e.g., the entire control plane) and may lower the delay in registering WTRUs.

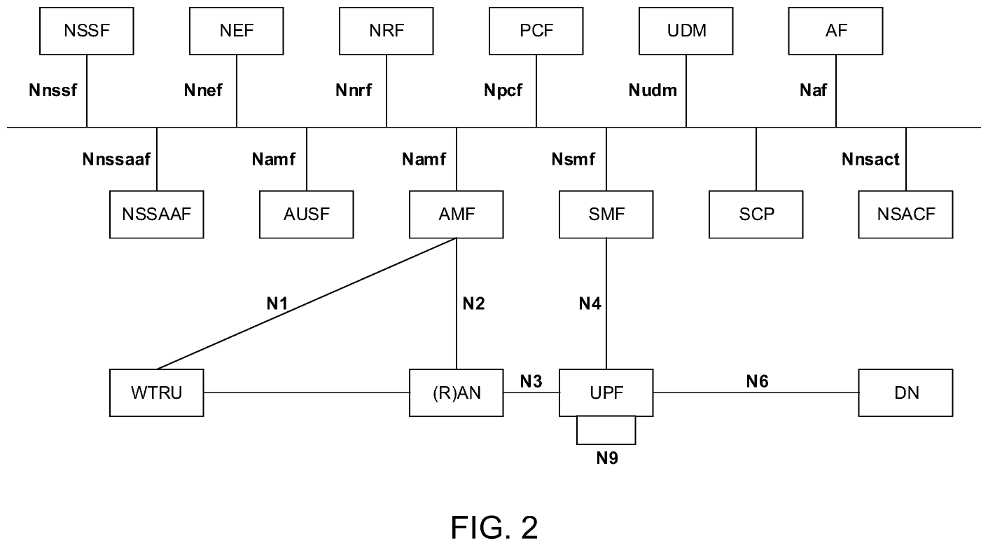

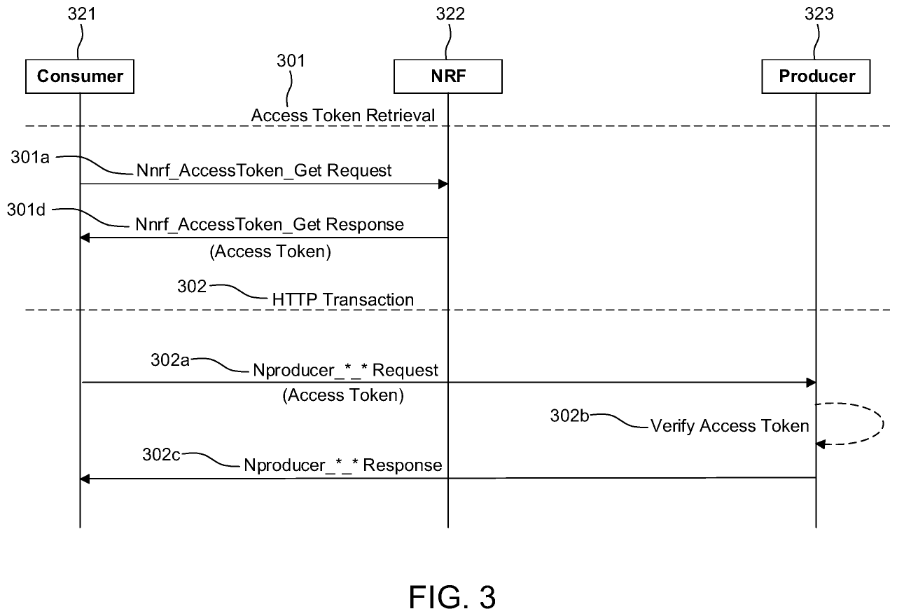

FIG. 2 illustrates an example of Service-Based Architecture (SBA). SBA may be structured as a set of Network Functions (NFs). A NF (e.g., each of the NFs) may represent a control plane functionality or data repository (e.g., as shown in FIG. 2). The separation of the control and data plane functionality, which may be used in SBA, may allow flexibility in deployment (e.g., centralized versus distributed or selective NF deployments for removing/adding optional Core Network features) and development of the core network. The NFs and their services may communicate and exchange information by using HTTP protocol over Service Communication Proxy (SCP), where SCP may act as an intermediary HTTP node. SBA may support (e.g., in addition) unified authentication architecture for 3GPP and non-3GPP network access. This architecture may maximize the 5G Core (5GC) benefits from different cloudification and virtualization techniques. In one example, there may be a User plane Function (UPF), Data network (DN), e.g. operator services or Internet access or 3rd party services, Access and Mobility Management Function (AMF), Authentication Server Function (AUSF), Session Management Function (SMF), Network Slice Selection Function (NSSF), Network Exposure Function (NEF), Network Slice Specific Authentication and Authorization Function (NSSAAF), NF Repository Function (NRF), Network Slice Admission Control Function (NSACF), Service Communication Proxy (SCP), Policy Control function (PCF), Unified Data Management (UDM), and/or Application Function (AF).

FIG. 3 illustrates an example of an access token-based consumer/producer communication. Examples of authentication between consumer and producer may be provided herein. The Nnrf_AccessToken_Get example may allow consumers to retrieve an access token. If a consumer aims to communicate with a producer, the consumer may contact the NRF to retrieve an access token based on credentials of any sort (e.g., credentials, certificates, pre-installed keys). If the Network Repository Function (NRF) responds with a token, the consumer may communicate with any producer using the access token (e.g., as shown in FIG. 3). Producers may verify the identity and validity of access tokens themselves via a master key or certificate.

As shown in FIG. 3, there may be a consumer 321, an NRF 322, and a producer 323. Initially, at 301, there is an access token retrieval process. At 301a, a first message may be sent from consumer 321 to NRF 322; this message may include a request for an access token. At 301d, a second message may be sent from the NRF 322 to consumer 321, which may include a response to the request, and more specifically the access token that was requested. At 302, there may be an HTTP transaction process (e.g., based on the access token retrieval). At 302a, a third message is sent from consumer 321 to producer 323, the third message may indicate a request and include the previously retrieved access token. At 302b, the 323 producer may verify the access token. At 302c, a fourth message may be sent from the producer 323 to the consumer 321, the message including a response to the request. Generally, a consumer and a producer may be any type of device disclosed herein.

In some cases, there may be one or more approaches for authentication for WTRUs. In some examples, security procedures and architecture may be provided with multiple core NFs involved in the authentication process. Authentication and Key Management (AKA) on the Extensible Authentication Protocol framework (EAP-AKA) may be used. The mutual authentication technique, which may be based on challenge and response technique (e.g., as discussed herein), may be deployed between the WTRU and CN. Authentication may be initiated by the WTRU and challenged by the network to verify the WTRU identity (e.g., as described further herein).

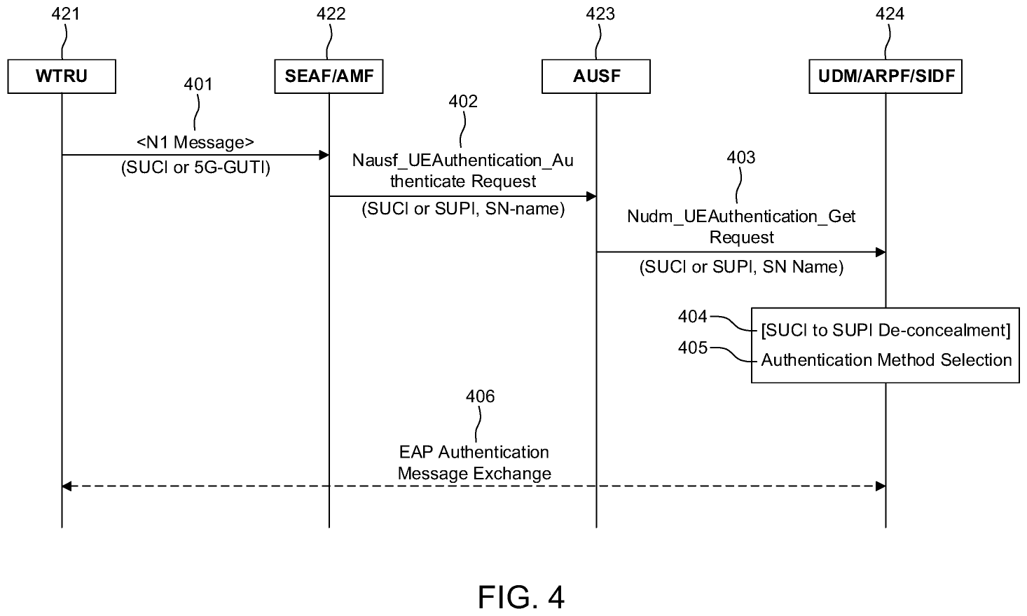

FIG. 4 illustrates an example of an authentication initiation messaging exchange. In this example, there is a WTRU 421, SEAF/AMF 422, a AUSF 423, and a User Data Management (UDM)/Authentication Credential Repository Function (ARPF)/Subscription Identifier De-concealing Function 424. The WTRU 421 authentication process may start with the WTRU 421 sending an identifier at 401, such as a Subscription Concealed Identifier (SUCI) or 5G GUTI (5G Globally Unique Temporary Identifier), to the AMF/SEAF 422. At 402, the AMF/SEAF 422 may send a request message, such as a Nausf_UEAuthentication_Authenticate Request message, to AUSF 423. This message may include the identifier (e.g., SUCI) and the serving network name. If receiving the message in AUSF 423, AUSF 423 may check the WTRU 421 serving network name and may compare it with the expected serving network name. If the WTRU 421 serving name and the expected serving network name do not match, AUSF 423 may send a response message, such as in a Nausf_UEAuthentication_Authenticate Response message, indicating that the serving network is not authorized (not shown). If the WTRU 421 serving name and the expected serving name match, a request message at 403, such as a Nudm_UEAuthentication_Get Request message, may be sent from AUSF 423 to UDM/ARPF/SIDF 424. This request message may include: a WTRU identifier, such as a WTRU SUCI or Subscription Permanent Identifier (SUPI); and/or the serving network name. If receiving the identifier (e.g., SUCI) within the request message, such as the Nudm_UEAuthentication_Get Request message, at 404 the UDM 424 may invoke the Subscription Identifier De-concealing Function (SIDF) 424 to gain the SUPI before replying to the request. At 405, based on the SUPI value, the UDM 424 may decide the authentication mechanism. In some instances, the SUPI may be sent (e.g., sent directly) from the WTRU instead of the SUCI. The authentication may (e.g., may then) start (e.g., 406 EAP Authentication Message Exchange).

There may be one or more approaches for authentication challenges of WTRUs using Authentication and Key Management (AKA) on the Extensible Authentication Protocol framework (EAP-AKA) or 5G-AKA. Authentication mechanisms used to challenge the WTRU in a network, such as a 3GPP network, may be selected by the UDM NF. The UDM may select the technique based on user identity and configured policy. Both Extensible Authentication Protocol-Authentication and Key Agreement (EAP-AKA) and 5G Authentication and Key Agreement (5G AKA) techniques may be used in 5G or later networks. AKA may be based on a challenge and response mechanism and symmetric cryptography (shared key).

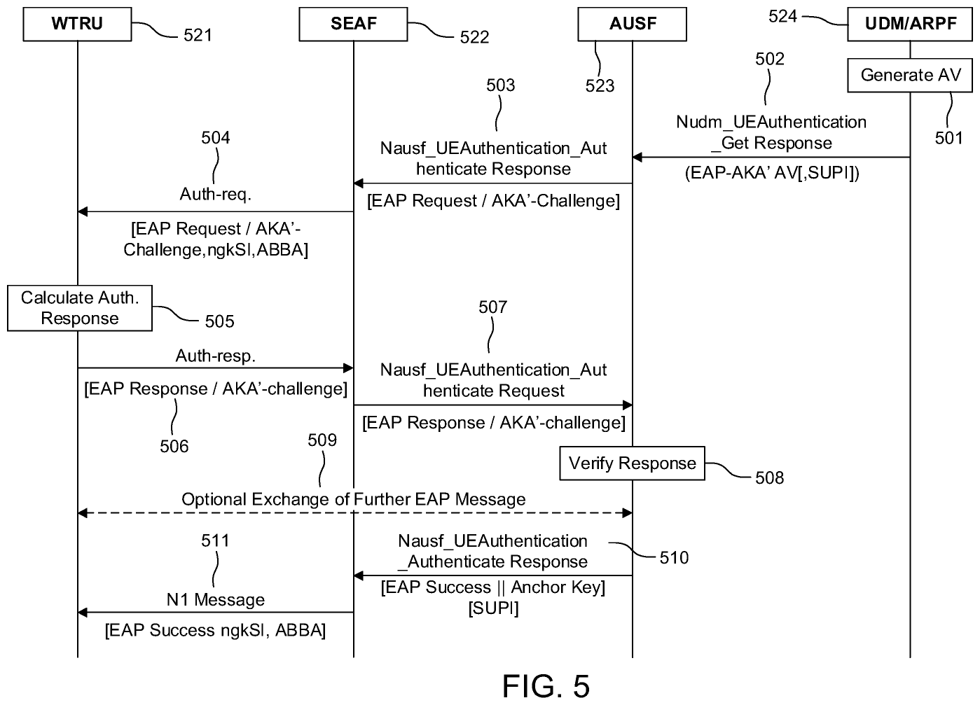

FIG. 5 illustrates an example of an Extensible Authentication Protocol-Authentication and Key Agreement (EAP-AKA). In this example, there may be a WTRU 521, a Security Anchor Function (SEAF) 522, an AUSF 523, and a UDM/ARPF 524. EAP-AKA is a protocol in the EAP framework that uses AKA to share and distribute keys. In this EAP-AKA, at 501, the UDM 524 may generate an authentication vector (AV) (e.g., Random Number (RAND), network authentication token (AUTN), expected response (XRES), CK′, integrity key (IK′)) with an Authentication Management Field (AMF) separation bit=1 and may (e.g., may then) send it to AUSF 523 at 502. At 503, AUSF 523 may send the EAP-Request/AKA′-Challenge message to the SEAF/AMF 522 in a response message, such as a Nausf_UEAuthentication_Authenticate Response message. At 504, if receiving the message from AUSF 523, the SEAF 522 may forward the EAP-Request/AKA′-Challenge message to the WTRU 521 in a NAS message Authentication Request message. The SEAF 522 may include the 5G Key Set Identifier(ngKSI) and 5G Anti-Bidding down Between Architectures (ABBA) parameter in an EAP-Authentication request message (e.g., in all EAP-Authentication request messages) to the WTRU 521. At 505, the WTRU 521 may calculate K_{SEAF} in a similar or same manner as AUSF 523. The AMF may identify the partial native security context that is created if the authentication is successful (not shown). The AMF may set the Anti-bidding down between architectures (ABBA) parameter.

Continuing in the example of FIG. 5, at 506, the WTRU 521 may send to the SEAF 522 an authentication response (e.g., EAP response/AKA challenge). At 507, the SEAF 522 may send an authentication request to AUSF 523 (e.g., effectively forwarding the EAP response/AKA challenge back to AUSF 523). At 508, AUSF 523 may verify the response. At 509, there may be an option exchange of further EAP messages. At 510, AUSF 523 may send to the SEAF 522 an authentications response message, which may include an indication of EAP success, an anchor key, and/or a SUPI. At 511, the SEAF 522 may send a message (e.g., N1 message) to the WTRU 521, which may include EAP Success ngkS and/or ABBA.

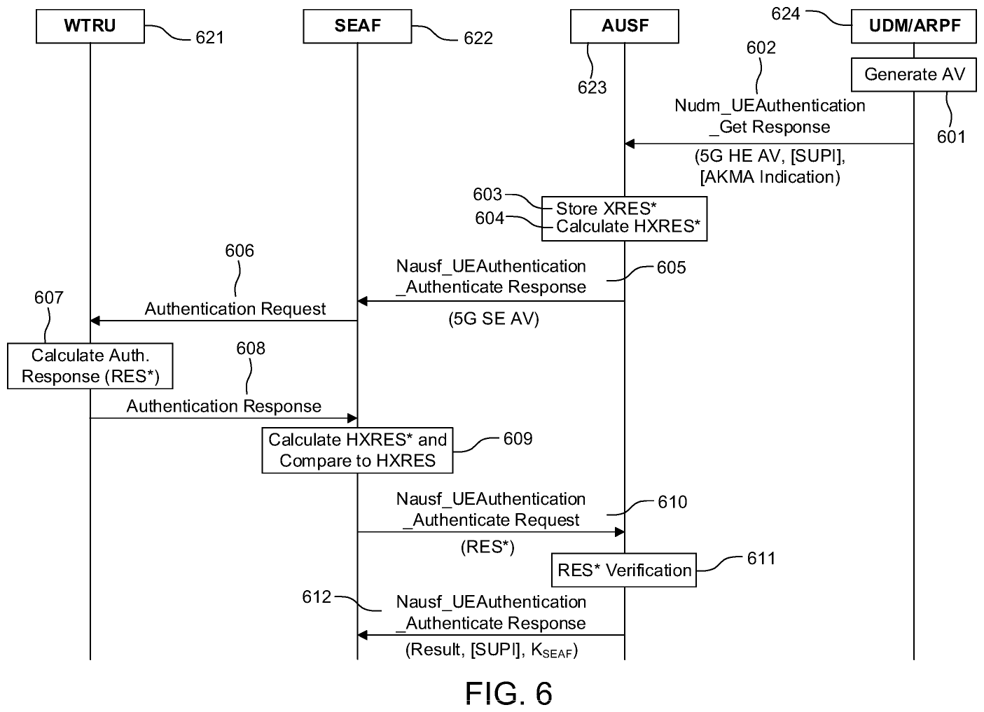

FIG. 6 illustrates an example of authentication response messaging that may use an AKA, such as 5G-AKA. In this example, there may be a WTRU 621, a Security Anchor Function (SEAF) 622, an AUSF 623, and a UDM/ARPF 624. 5G-AKA may be considered to be an enhancement of EAP-AKA where the home network may receive confirmation of the WTRU's successful authentication (see FIG. 5 for details that also apply to FIG. 6). With this authentication technique, UDM/ARPF 624 may calculate the KAUSF from CK, IK, and Serving Network Name (SNN) and may generate the 5G Home Environment Authentication Vector (5G HE AV) (e.g., at 601). The 5G HE AV may include the RAND, AUTN, XRES*, and Key AUSF (KAUSF). At 602, the 5G HE AV may be sent via a Nudm_UEAuthentication_Get Response message to AUSF 623. AUSF 623 may store both SUCI/SUPI and XRES* temporarily (e.g., at 603). At 604, AUSF 623 may generate 5G SE AV from the received 5G HE AV (e.g., including the hashed XRES (HXRES*). At 605, AUSF 623 may send the 5G SE AV which may include RAND, AUTN and HXRES* to SEAF 622. At 606, SEAF/AMF 622 may send transparently AUTN, RAND to the WTRU 621. At 607, WTRU 621 may calculate the RES and RES* and send them alongside CK and IK to the SEAF 622, over the Authentication Response message (e.g., at 608). At 609, SEAF 622 may calculate HRES* from HRES and may compare HRES* with HXRES to check if there is a match or not. If there is a match, at 610, SEAF 622 may consider the authentication successful and may send RES* alongside the other content of the Authentication Response message to AUSF 623. At 611, AUSF 623 may check if RES* matches the stored XRES *. If the RES* AND XRES* are matched, AUSF 623 may consider the authentication successful and may store the KAUSF. At 612, AUSF 623 may send the Nausf_UEAuthentication_Response (e.g., result, [SUPI], K_{SEAF}) to SEAF 622, which may transparently send it to WTRU 621 (not shown). The UDM may be informed (e.g., may also be informed) that the authentication is successful.

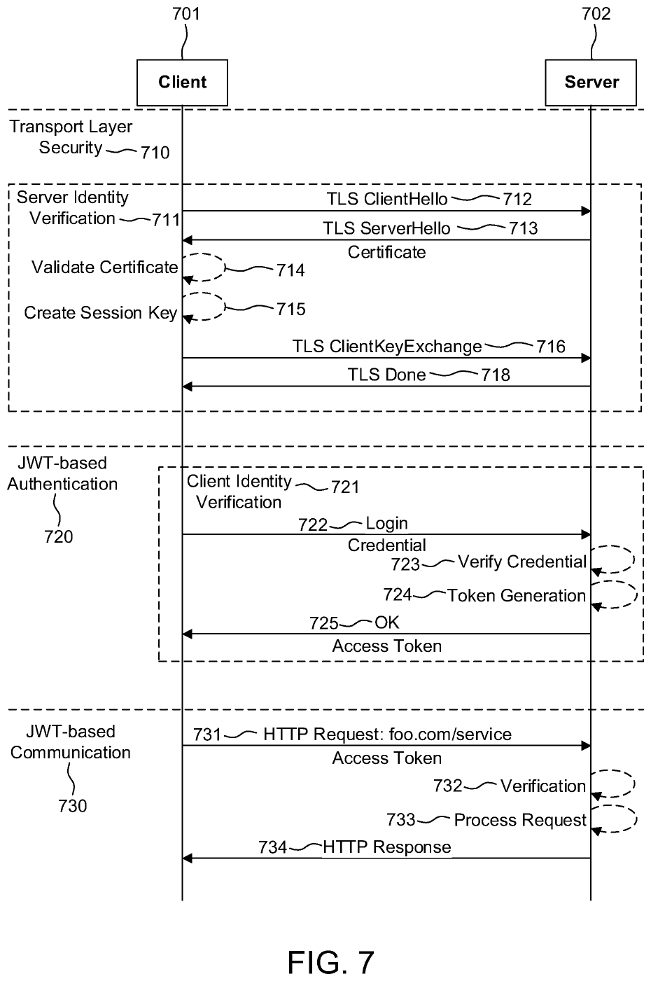

FIG. 7 illustrates an example of an authentication and encryption procedure for client-server communication, which may be on the Internet. In this example, there may be a client 701 (e.g., WTRU) and a server 702 (e.g., any device connected to a network and accessible by the client). For services publicly available over the internet, different security procedures may enable several levels of securities-related (e.g., mainly related) to authorization, but related (e.g., partially related) to authentication too. Transport Layer Security (TLS) may be a protocol for securing the communication between a client and a server. TLS is a certificate-based protocol that may enable the verification of server identities so that clients may be assured they are communicating with the entity they intend to start a message exchange. Root certificates (e.g., all root certificates) may be signed and issued by trusted authorities and may be verified online. A client application (e.g., each client application on a WTRU) may independently verify a server and its certificate (e.g., as a result). If the TLS session has been established, plain text information may be exchanged with the server, which may be encrypted along the transport link (e.g., as shown in (710) of FIG. 7). Here, server identify verification process 711 may include a first TLS message 712 (e.g., TLS client hello) of the client 701 sent to the server 702. Server 702 may send back a response message 713 that includes a certificate (e.g., TLS server hello). The client 701 may validate the certificate at 714, and create a session key at 715. Client 701 may then send the key to server 702 at 716 (e.g., TLS client key exchange), and the server may respond at 718 confirming that TLS has been completed.

If a secure channel between the client and the server and the validation of the server's identity is completed (e.g., the process of the TLS 710), the client 701 may authenticate itself which may allow the server to verify the identity of the client. A TOKEN-based approach may be used, such as the JSON Web Token (JWT) Authentication 720, where the client may provide its credentials (e.g., certificate or username+password, as shown in (720) in FIG. 7). For example, there may be a process of client identity verification 721. At 722, the client 701 may send login information, such as credential information, to server 702. At 723, the server 702 may verify the credentials. At 724, the server 702 may generate a token. At 725, server 702 may send an OK message in response to the login, which includes the generated token (e.g., access token).

The client 701 may use the generated token for communications (e.g., for every communication) with the server 702, which may allow the server to verify the client (e.g., as shown with respect to JWT-based communication 730 in FIG. 7). This verification may be based on a shared master key across the client and servers as part of the application. For example, at 731, the client may send an HTTP request for a specific website to server 702. The request may include the token. At 732, the server 702 may verify the access token. At 733, the server 702 may process the HTTP request. At 734, server 702 may send an HTTP response based on processing the request, to the client 701.

According to one or more techniques described herein, there may be methods and procedures for one or more WTRUs to communicate directly to Core Network Function(s) without the need to go through an Access and Mobility Function (AMF). As part of utilization of N1 that will use HTTP instead of the Non-Access Stratum protocols, there is a need for methods for a device (e.g., WTRU), which will permit the usage of HTTP semantics. One or more techniques described herein may allow the unification of authentication procedures for trusted and untrusted non-3GPP Access Networks.

A non-3GPP network may be an IP network with an access network that is not defined in 3GPP. Two types of non-3GPP networks may be considered, as examples, and may be discussed herein: trusted and untrusted non-3GPP networks. In any given network (3GPP or non-3GPP), there may be a registration process, as well as an authentication process that may involve a WTRU and one or more Network Functions (NFs). A network function may be a device and/or node, with similar or the same hardware as a WTRU described herein. In some cases, there may be one or more NFs discussed herein that are embodied in software, but operate from the same hardware. In some cases, reference to one NF may, indirectly, also refer to another NF given that two NFs may operate from the same node.

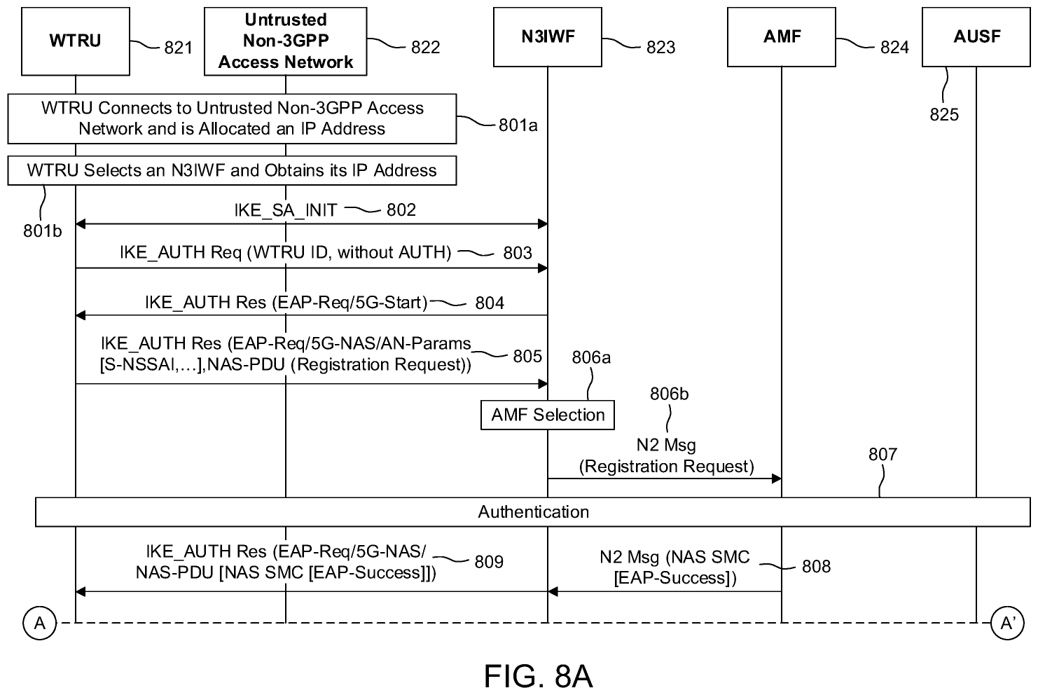

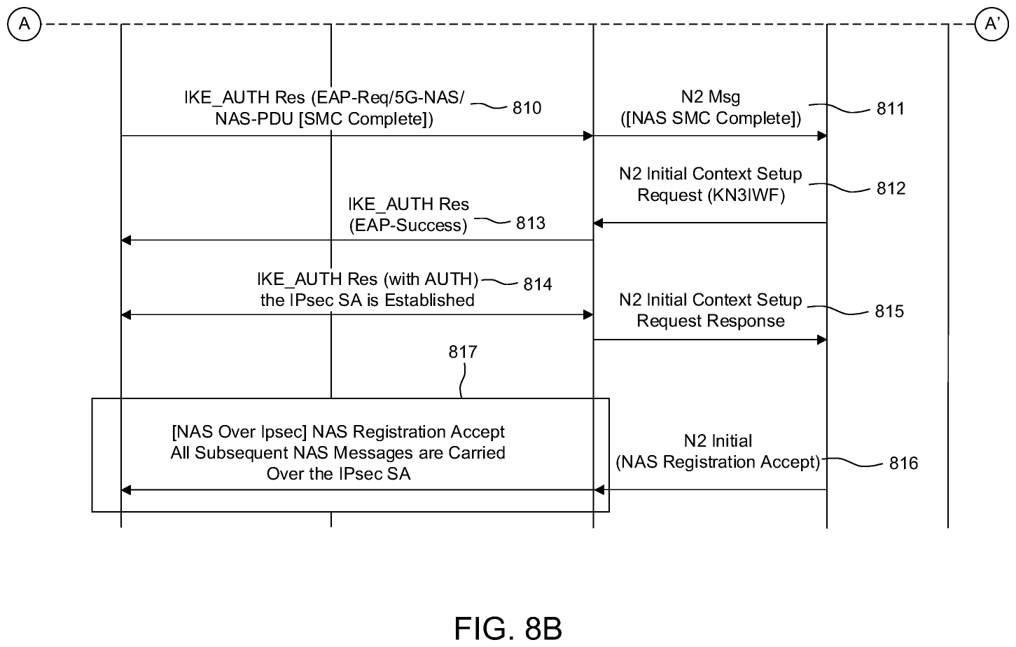

FIG. 8 (FIG. 8A, FIG. 8B) illustrates an example registration/authentication process for untrusted non-3GPP access. As shown, there may be a WTRU 821, an untrusted non-3PP network 822, a non-3GPP Interworking Function (N3IWF) 823, an AMF 824, and an AUSF 825. For non-3GPP networks, initially, an example registration process may start with the WTRU 821 connecting the untrusted non-3GPP network at 801a, where it also may be allocated an IP address. At 801b, WTRU 821 may select the appropriate NF, such as the non-3GPP Interworking Function (N3IWF) 823, which may assign an IP to WTRU 821.

At 802, the WTRU may initiate an IPsec secure exchange with the selected N3IWF by starting IKE initial exchange.

At 803, the channel becomes secure for WTRU 821 to start the authentication, so, an authentication request message, (IKE_AUTH_Req), may be sent by WTRU 821 to the N3IWF 823 (e.g., this may include a WTRU ID without authentication).

At 804, N3IWF 823 may respond with a response message containing N3IWF identity, the authentication payload, and Extensible Authentication Protocol-Request/5G-Start (EAP-Request/5G-Start) packet to inform WTRU 821 of the need to initiate EAP session and send all the non-Access Stratum (NAS) data encapsulated in the corresponding frames. If a (Certificate Request) CERTREQ is sent in the request message, then at 804, N3IWF certificate may be included in the response to WTRU 821.

At 805, WTRU 821 may confirm N3IWF 823 identity and send a response (IKE_AUTH) comprising a EAP/5G-NAS request that includes the registration request and the Subscription Concealed Identity (SUCI). If the WTRU is already attached over a 3GPP network, the WTRU may send 5G-Globally Unique Temporary Identity (5G-GUTI) instead of SUCI.

At 806a, N3IWF 823 selects AMF 824, and sends a message requesting registration to at 806b, in which WTRU 821 may communicate with.

If the selected AMF 824 decided to authenticate WTRU 821, then at 807, an authentication process is performed (e.g., further described herein) where NAS messages sent from AUSF 825 to AMF 824 and N3IWF 823 to the WTRU 821 and vice versa to finalize the authentication.

The anchor key K_{SEAF} may be sent in the last authentication message to AMF 824 with the EAP success message (e.g., in case the EAP AKA protocol is used). AMF 824 may send EAP success message to WTRU 821, which may derive the KSEAF and consequently the K_{AMF} (not shown).

At 808, AMF 824 may send the security Mode Command (SMC) to N3IWF 823 to activate security associated with NAS identifier, which will be sent to WTRU 821 by the N3IWF 823 at 809 (e.g., in case of EAP-AKA, the EAP success message is encapsulated by AMF 824 in the SMC message and sent to WTRU 821).

At 810, WTRU 821 may now complete the authentication procedure and send complete in the EAP-5G Response NAS SMC to N3IWF 823, which forwards it at 811 to AMF 824 over an N2 interface.

At 812, AMF 824 may initiate the NG Application Protocol (NGAP) procedure to set up the AN context and compute N3IWF key (K_{N3IWF}) to establish the IP Security Association (IPsec SA) between WTRU 821 and N3IWF 823 and send it in the NGAP initiation request to N3IWF 823.

At 813, N3IWF 823 may send an EAP-Success/EAP-5G to WTRU 821 upon reception of the NGAP Initial Context Setup Request and no further EAP-5G may be sent.

Then, IPsec may be established. By using the N3IWF key K_{N3IWF} that was created in the AMF 824, at 814, the IPsec SA may be established between WTRU 821 and N3IWF 823 may consequently send at 815 the NGAP Initial Context Setup Response message to AMF 824.

At 816, AMF 24 may send the NAS Registration Accept message to WTRU 821 over the N2 through N3IWF 823 when NGAP Initial Context Setup Response for the WTRU is received by AMF 824.

At 817, N3IWF 823 forwards the NAS Registration Accept message over IPsec to WTRU 821 so WTRU 821 is fully registered in the network at this point.

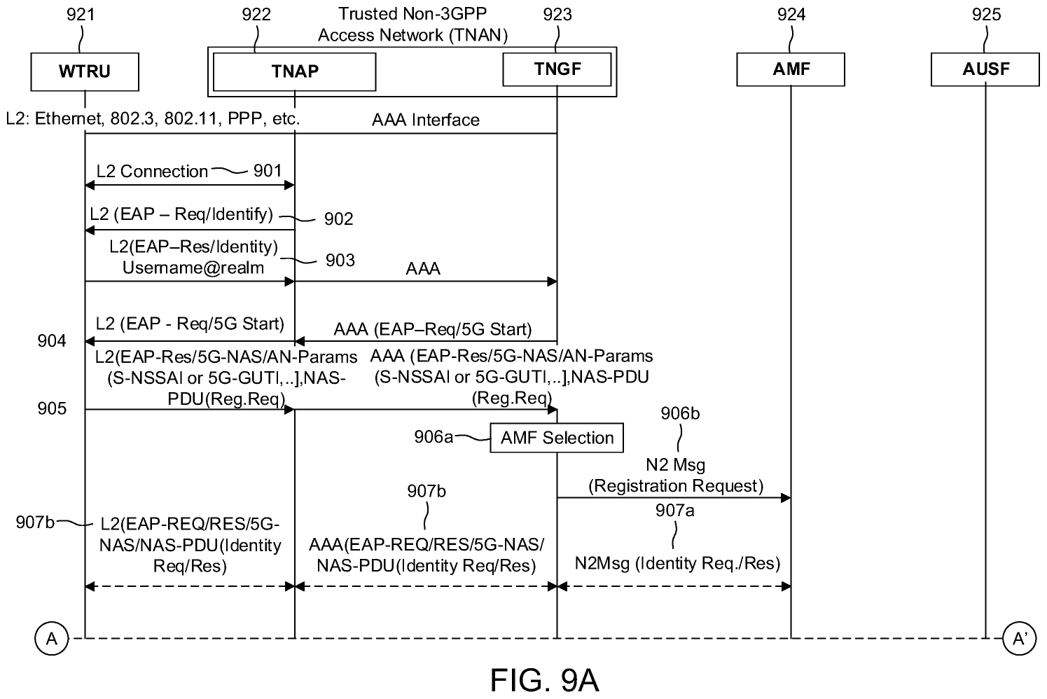

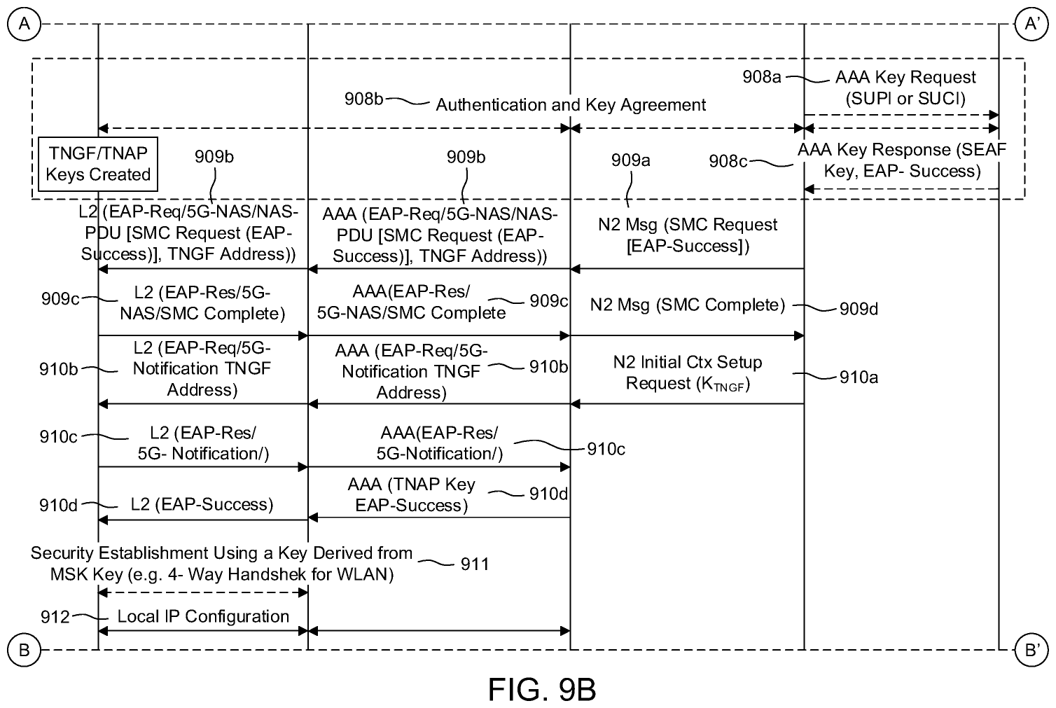

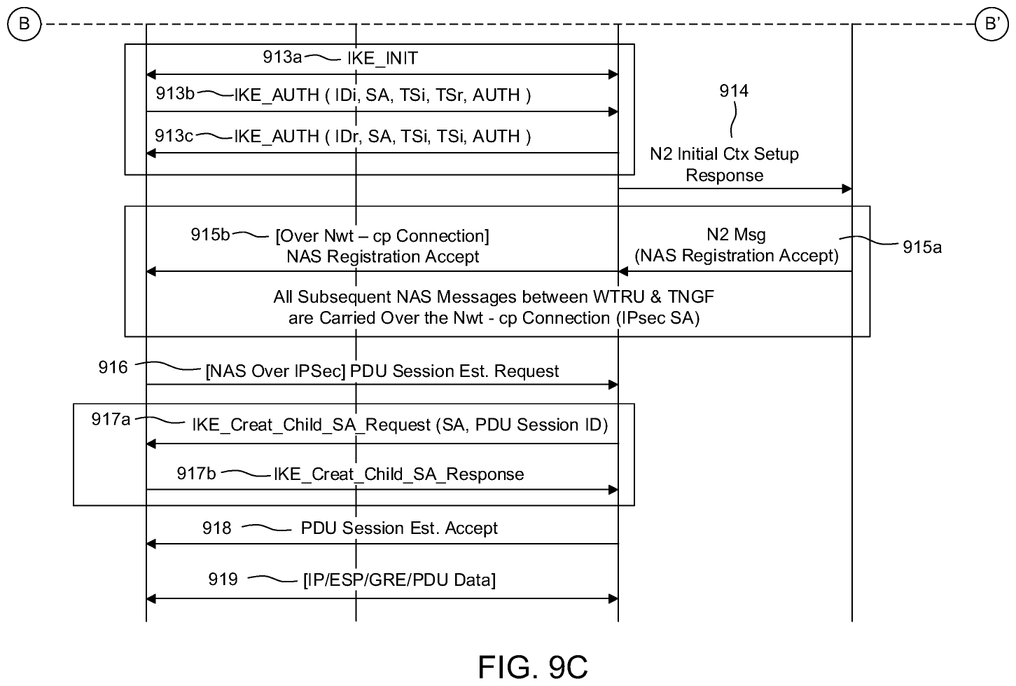

FIG. 9 (FIG. 9A, 9B, 9C) illustrates an example of registration/authentication and PDU session establishment for trusted non-3GPP access.

Generally, a Trusted Non-3GPP Access Network (TNAN) is a type of non-3GPP network that is trusted by the home provider network, as it can control the non-3GPP network and trusts their access points. TNAN may comprise of Two Network Functions (NFs): Trusted non-3GPP Access Point (TNAP) and Trusted non-3GPP Gateway Function (TNGF). TNAP may be equivalent to a WLAN access point and allows WTRUs to connect to the TNGF, while the TNGF allows the WTRU to connect to the 5GC.

As shown in FIG. 9, there may be a WTRU 921, TNAP 922, TNGF 923, AMF 924, and an AUSF 925. There may be a non-3GPP access between WTRU 921 and the TNAP 922 (e.g., ethernet 802.3, 802.11, PPP, etc.).

At 902, the procedure of authenticating the WTRU with the 5GC in this type of network may start with WTRU authenticating with TNAP by using EAP-based procedure.

The WTRU may send the EAP message framed according to the used non-3GPP protocol, IEEE 802.3/802.1x, IEEE 802.11/802.1x or PPP protocol. After that, EAP 5G procedure may be executed as disclosed herein (e.g., FIG. 8), but with extra three messages from TNGF to WTRU which are EAP-Request/5G-Notification packet containing the “TNGF Contact Info” message, EAP-Success packet message from TNGF to WTRU, and message from TNGF to TNAP to transfer KTNAP (e.g., 903, 904, and 905).

After that, TNGF 932 may select the AMF 906a and send the received registration request from WTRU 921 to the AMF 924 at 906b.

At 907a and 907b, AMF 924 may send an identity request to WTRU 921, and receive the response accordingly.

At 908a, 908b, and 908c, if AUSF 925 decided to authenticate WTRU 921, AUSF 925 may challenge the WTRU in this process (e.g., as further disclose herein.

At 909a, 909b, 909c, 909d, 909e (collectively 909), WTRU 921 may receive the authentication challenge results from AMF 924 through TNAN 922/923.

At 910a, if the authentication result is a success, TNGF 923 may receive an initial Context request from AMF 924. 910, generally (a-d), may represent a process of exchanging messages leading to EAP success.

At 911, there may be security establishment.

At 912, there may be local IP configuration.

At 913, Internet key exchange (IKE) may be carried out.

At 914, TNGF 923 responds to AMF 924 setup request with an N2 Initial Context Setup Response message when the NWtp connection is successfully established.

At 915a, AMF 924 may send a NAS Registration Accept message to TNGF 923, which may be forwarded at 915b to WTRU 921 via the established NWt connection.

In some instances, at 916, there may be a NAS message over IPsec with PDU establishment request.

At 917, IKE may be performed again, with PDU session ID.

At 918, once PDU session is established, then at 919 there may be an exchange of data and the like.

Problems may arise related to procedures for authenticating WTRUs in non-3GPP Access Networks. For example, there may be NAS incompatibility with an end-to-end SBA. In some cases, a WTRU may attempt to communicate with a Core Network using an N1 interface utilizing the NAS protocol, however, NAS cannot be used with the proposed SBA as it has different semantic, as SBA in utilizes HTTP for the communication between CN NFs. In summary, the WTRU may not be able to access a SBA CN with an N1 interface as the only available interface and there may be an absence of any SBI solution. To address this and other related issues, there may be one or more solutions embodied in techniques and approaches disclosed herein.

There may be one or more problems related to procedures for authenticating WTRUs in non-3GPP Access Networks. For example, there may be fragmented authentication procedures for trusted and/or untrusted non-3GPP networks. A major problem of some approaches with the 5GC is that the authentication of WTRUs in different types of networks (e.g., 3GPP and trusted and untrusted networks) is performed by different methods and procedures. This increases the complexity of realizing the standardized system network. It also complicates the implementation of any solution that requires orchestration of multi-vendor networks. In summary, different network types attached to the 5GC (e.g., trusted and untrusted non-3GPP networks) may use different methods and procedures to perform the authentication service, increasing the authentication deployment complexity and reducing the ability to orchestrate multi-vendors solutions. To address this and other related issues, there may be one or more solutions embodied in techniques and approaches disclosed herein.

Another problem that may arise in non-3GPP access networks is that there may be a single point of entry from the WTRU towards the SBA NFs and vice versa. In some cases, for SBA, authentication messaging may go through the AMF NF as the WTRU has no SBI to communicate directly with the SBA NFs and use of the SCP routing capabilities. Also for SBA. the WTRU may communicate with the AMF over N1 interface which has different semantic than the interfaces in the End-to-End SBA. In summary, The WTRU is forced to send the traffic towards the AMF as it has no Service Based Interface to communicate directly with the End-to-End SBA NFs. To address this and other related issues, there may be one or more solutions embodied in techniques and approaches disclosed herein.

Another problem that may arise in non-3GPP access networks is that there may be authentication signaling and energy consumption in end-to-end 5G service-based architecture. In some cases, non-3GPP Access Network authentication procedures may go through the AMF for both trusted and untrusted non-3GPP Access Networks. The AMF may be contributing to the authentication procedures and generates keys to be communicated to the WTRU. However, in some scenarios, the AMF may not add any functionality to the authentication procedures anymore. This results in a significant percentage of all authentication messages being simply relayed by the AMF, which consequently results in a significant impact on the energy consumption of the entire Core Network for registering a WTRU. In summary, the AMF may act as a gateway between WTRU and all other Core Network Functions which results in unnecessary signaling and therefore energy consumption in the authentication procedures to register a WTRU. To address this and other related issues, there may be one or more solutions embodied in techniques and approaches disclosed herein.

Problems may arise in some 3GPP access network cases (e.g., based on some of the example cases provided herein), where N1 interfaces may be incompatible and service-based interfaces may be absent. WTRUs may (e.g., may only) access the CN through an AMF NF utilizing NAS and N1 interface. The NAS protocol may have different semantics than the one used in the End-to-End SBAs where the SBI interface and HTTP may be utilized for communication between CN NFs. In an example, the N1 interface may be the only available interface for the WTRU which may disallow the WTRU from attaching to the End-to-End SBA and benefit from its features.

In some 3GPP access network cases, there may be issues caused by signaling overhead and delays. The WTRUs may have access to CNs being overwhelmed with unnecessary messages due to the gateway behavior of the AMF. This may lead to higher signaling and consequently delay in the registration of a WTRU against a CN.

For example, WTRU attachment messages (e.g., any WTRU attachment messages) toward the CN may go through the AMF. The AMF may send the data transparently to the other NFs. There may not be a clear functional contribution from the AMF in the authentication process. If there is a clear functional contribution from the AMF in the authentication process, it may be limited to simple calculations that can be performed by NFs (e.g., any other NF). In authentication initiation examples (e.g., as discussed herein), the AMF may send the authentication request to the AUSF with no addition or change to the actual message.

Taking the delay KPI under consideration, if the average delay of each signal (e.g., message) in an NF due to different processing and serialization delays is DM, then the overall delay of the authentication process may be (DX):

D_{X}=Mₓ*D_{M}, where Mₓ is the number of authentication messages. So with a higher number of messages, the authentication process may take more time and may not provide an added benefit. Solutions to this and other problems may be addressed herein based on one or more disclosed techniques and approaches.

In some 3GPP access network cases, there may be issues arising from energy efficiency in SBA (e.g., 5G). For example, energy consumption (e.g., additional energy consumption) may be due to increased messaging due to the gateway behavior of an AMF NF. Processing, sending, and receiving messages by gateway NFs, such as an AMF, may cause excessive loads on these NFs where extra processing capabilities may be needed and more instantaneous service from these NFs may be required. The same may apply to other NFs in the 5GC, where receiving, sending, and processing unnecessary messages may lead to more loads on these NFs.

If the amount of energy consumed to construct and send one message is Eₓ, then the energy consumption for messaging with an EAP-AKA response is (the number of exchanged messages) 7*Eₓ (e.g., 7 being the number of exchanged messages in an EAP/AKA process as described herein).

If the number of authenticated WTRUs is WTRUₙ and the number of messages per authentication process (e.g., the number of messages required to authenticate a WTRU) is Mₓ, the overall power consumption due to messaging (Eₘ) may be: Eₘ=WTRUₙ*Mₓ*Eₓ.

To the previous energy consumption equation, a factor γ may be added, which represents the extra consumed energy as a result of creating multiple instances of the same NFs due to the high processing requirements for messaging and other network tasks. The equation may be as follows: Eₘ=(WTRUₙ*Mₓ*Eₓ)+γ.

Since 5GC introduces more signaling and messaging, as a result of disintegrating the CN, further optimization for the authorization messaging may introduce a significant reduction in the consumed energy. Accordingly, there is a need for approaches and techniques, which are described herein, that address these issues in 3GPP access network.

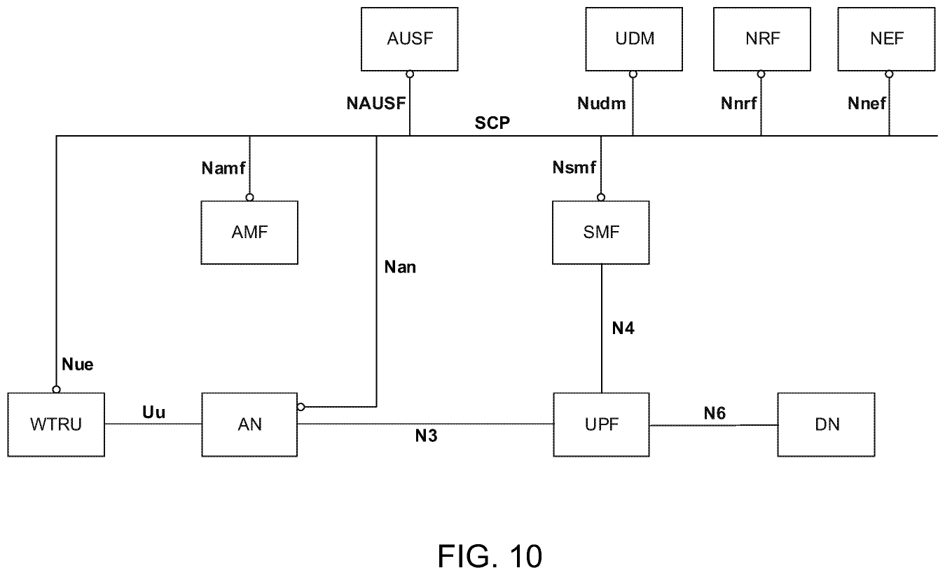

FIG. 10 illustrates an example of a system architecture for SBA-enabled WTRU authentication. This architecture may have a communication (e.g., direct communication) between the WTRU and the AUSF without any Gateway NFs. The authentication signaling may be proposed to use HTTP/2 or HTTP/3 where the WTRU has an SBI interface and acts like a consumer or producer similarly to other NFs in the CN. In the authentication process, the WTRU may act as a consumer if asking to be authenticated, and as a producer if challenged by the CN. In some instances, a Security Anchor Function (SEAF) functionality may be integrated into the AMF NF.

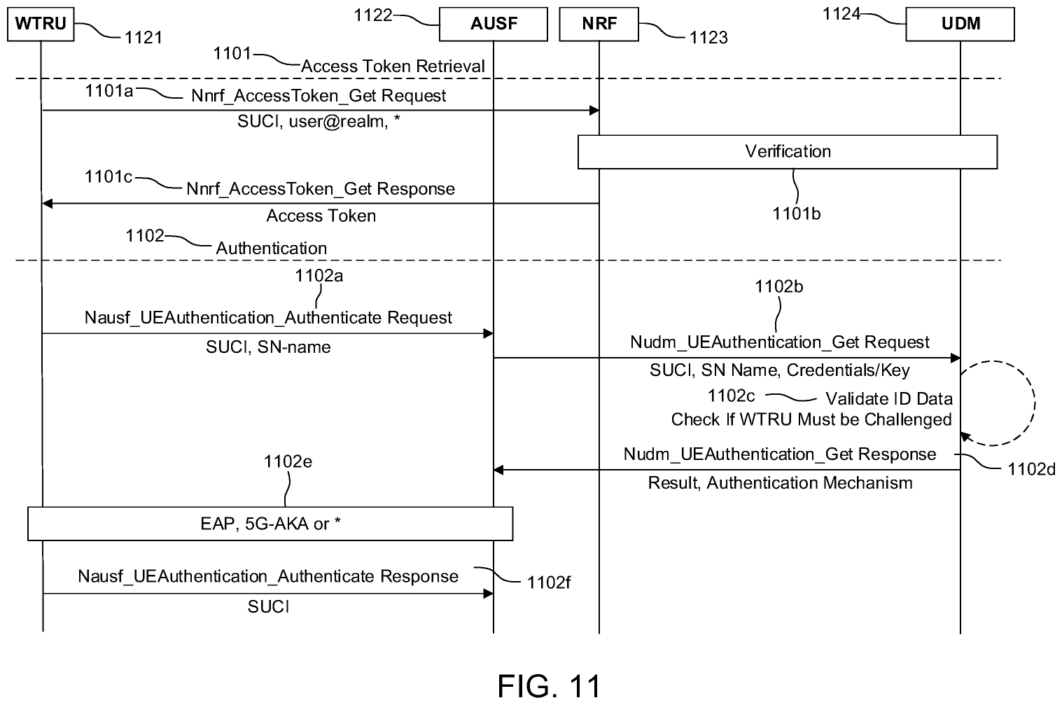

FIG. 11 illustrates an example of an authentication for SBA-Enabled WTRUs, such as a 6G standalone authentication for SBA-Enabled WTRUs. As shown, there is a WTRU 1121, an AUSF 1122, an NRF 1123, and a UDM 1124. For 6G SBA-Enabled WTRUs and CNs, NAS applications on WTRUs may communicate (e.g., communicate directly) with a 6G Core Network with an access token over HTTP sessions. In this example, the proxy behavior of the AMF may be removed. FIG. 11 depicts the message sequence chart for the 6G SA procedures. In at least one instance, one or more NF may address another one or more NF when the need arises.

As shown, there may be a WTRU authentication against a 6G core. The sequence of messages provided shown in FIG. 11 allow for WTRUs, generally, to retrieve an access token from the NRF. These procedures may follow one or more 5G procedures for SBI-enabled 5G NFs (e.g., as described herein). At 1101 may begin an access token retrieval process.

At 1101a, the WTRU 1121 may establish communication towards NRF 1123 using TLS as the underlying encryption. The WTRU 1121 may provide its identification (e.g., SUCI as a means of identification combined with optional K and OPc values identifying the WTRU). By establishing communication, the WTRU may send a request message (e.g., Nnrf_AccessToken_Get Request).

At 1101b, NRF 1123 may verify the received message. In some instances, NRF 1123 may request the validation of the provided data from UDM 1124 utilizing the Nudm_UEAuthentication_Get request (depicted as 1101b in FIG. 11). UDM 1124 may validate the WTRU 921 data against its database and may check if further authentication mechanisms are required. If the provided identification data from WTRU 1121 is verified as correct, UDM 1124 may respond with a positive Nudm_UEAuthentication_Get response (depicted as 1101b in FIG. 11).

At 1101c, if response from the UDM 1124 indicated that the identification data provided by the WTRU 1121 was correct, the NRF 1123 may respond back to the WTRU 1121 with an Nnrf_AccessToken_Get response, including the access token. The NRF 1123 may relay (e.g., may further relay) any additional authentication mechanisms. This may allow the WTRU 1121 to learn if it can proceed (e.g., immediately proceed) with the registration procedures or if it may wait for any further authentication challenges.

At 1100, the authentication process may begin following a successful access token retrieval process at 901, and in some instances, the WTRU 1121 may be challenged before it can be registered with the network (e.g., as provided herein).

At 1102a, WTRU 1121 may request an authentication utilizing Nausf_UEAuthentication_Authenticate request message at 1102a.

At 1102b, AUSF 1122 may utilize the Nudm_UEAuthentication_Get request to check with UDM 1124 the WTRU 921 identity and if further authentication is needed.

At 1102c, UDM 1124 may validate the user identity and if further authentication is required (e.g., challenged).

At 1102d, based on the outcome of 1102c, UDM 1124 may request, from AUSF 1122, performance of further authentication procedures for the unregistered WTRU 1121 using the Nudm_UEAuthentication_Get response.

At 1102e, AUSF 1122 may challenge WTRU 1121 based on EAP-AKA, 5G-AKA, or any other authentication mechanism. The WTRU may be informed about which authentication mechanism may be used by AUSF in 1102e.

At 1102f, if the authentication procedures between AUSF 1122 and WTRU 1121 are completed, AUSF 1122 may respond to the request from WTRU 1121 (e.g., that was sent at 1102a) with the outcome using the Nausf_UEAuthentication_Authenticate response message.

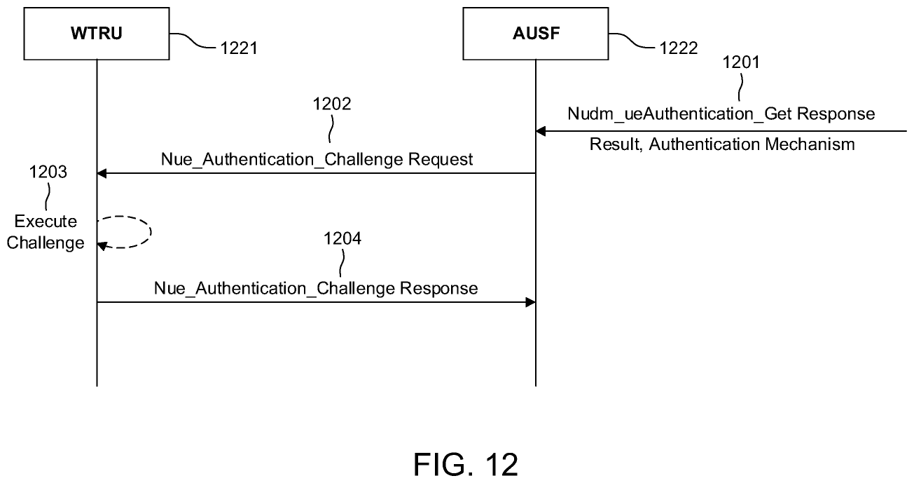

In some cases, the authentication challenge (e.g., additional authentication challenge) in 1102e may be indicated and may be described in further detail in FIG. 12, which may allow the visual decoupling of procedures for demonstration purposes. In one instance, one or more WTRUs may not be challenged (e.g., at all) further by AUSF 1122.

FIG. 12 illustrates an example of a message sequence chart for challenging a WTRU in a 6G SA scenario. Examples of authentication challenges for WTRUs may be provided herein. As in some wireless systems (e.g., 5G), the CN may (e.g., may further) challenge the WTRU as part of its authentication, as indicated in at 1202e.

As shown in FIG. 12, at 1201 a challenge message may be sent from the UDM (not shown) to AUSF 1222 utilizing the Nudm_UEAuthentication_Get response. The message may include the re (EAP-AKA′ AV [, SUCI]) in the case of EAP-AKA or the (5G HE AV, [SUCI]) in the case of 5G-AKA.

At 1202, the challenge message may be sent from AUSF 1222 to the WTRU 1221 using the Nue_Authentication_Challenge request message. The message may include an EAP Response/AKA′-Challenge/ABBA/ngKSI in the case of EAP-AKA and a RAND, AUTN in the case of 5G-AKA.

At 1203, the WTRU 1021 may calculate the challenge response.

At 1204, the WTRU 1221 may send the challenge response utilizing the Nue_Authentication_Challenge response. The message may include an EAP-Response/AKA′-Challenge in the case of EAP-AKA and a RES* in the case of 5G-AKA.

Examples of 6G Non-Standalone (NSA) authentication for SBA-Enabled WTRUs may be provided herein. Examples may be provided for enabling 6G WTRUs to communicate with a 5G CN. The concept of the AMF may lawfully intercept the WTRU communication and proxying it may take place in “6G Non-Standalone (NSA)” mode.

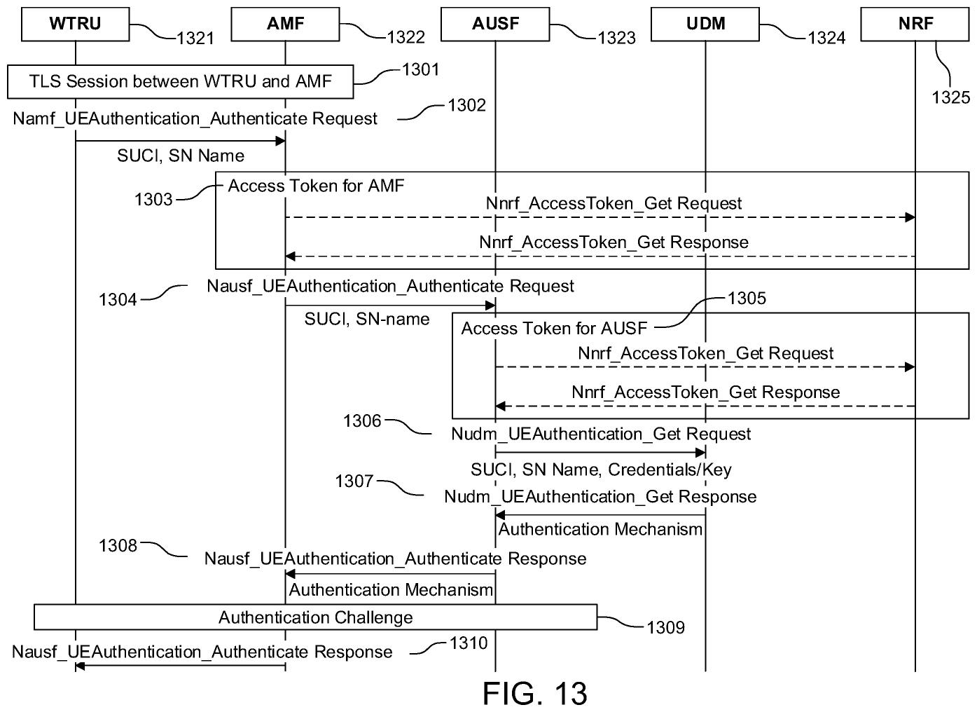

FIG. 13 illustrates an example of non-standalone authentication procedures, such as 6G NSA authentication procedures for SBI enabled 6G WTRUs with a 5G Core. Examples of authentication against 5GC via SBI enabled AMF may be provided herein. FIG. 13 depicts the message sequence chart for 6G NSA procedures. The sequence of messages may allow for WTRUs to initiate the authentication procedures. As shown, there may be a WTRU 1321, AMF 1322, AUSF 1323, UDM 1324, and NRF 1325.

At 1301, WTRU 1321 as a consumer may establish a communication towards AMF 1322 as a producer (e.g., optionally using TLS as underlying encryption). At 1302, using a (e.g., new) request message (e.g., Namf_UEAuthentication_Authenticate), WTRU 1321 may provide its SUCI in the request as a means of identification combined with optional K and OPc values identifying WTRU 1321.

At 1303, AMF 1322 may obtain an access token from NRF 1325 to communicate with NFs (e.g., any other NF) utilizing a request message and then receiving a response message (e.g., Nnrf_AccessToken_Get request/response primitives). If AMF 1322 still has a valid access token from previous communications, 1303 may be skipped.

At 1304, using the access token, AMF 1322 may send a message (e.g., utilizing the Nausf_UEAuthentication_Authenticate request primitive), combined with the information received from the WTRU in 1301, to request the authentication of WTRU 1321 from AUSF 1323.

At 1305, if AUSF 1323 has no valid access token (e.g., no valid access token anymore), it may send and receive a request/response message, respectively (e.g., utilizing the Nrf_AccessToken_Get Request/Response primitive), to acquire an access token (e.g., a new access token) from NRF 1325.

At 1306, AUSF 1323 may send a request message (e.g., utilizing a Nudm_UEAuthentication_Get) to the UDM to check the identity of WTRU 1121 and if (e.g., further) authentication is needed.

At 1307, UDM 1324 may validate the WTRU data against its data base and check if (e.g., further) authentication mechanisms are required. If the provided data from the WTRU is satisfied, the UDM may send the response message to AUSF 1323 (e.g., utilizing a Nudm_UEAuthentication_Get response).

At 1308, if the response from UDM 1324 indicated that the identity data provided by the WTRU was correct, AUSF 1323 may respond back to AMF 1322 with a response message (e.g., Nausf_UEAuthentication_Authenticate). The response may include the authentication mechanism if (e.g., further) authentication is required. This message content may allow WTRU 1321 to learn if it can proceed (e.g., immediately proceed) with the registration procedures or if it may wait for any (e.g., further) authentication challenges.

At 1309, in case WTRU 1321 may be challenged before it can be registered with the network, the EAP-AKA or 5G-AKA authentication mechanisms may take place. If such a challenge takes place (not shown), a challenge request may be sent from AUSF 1323 to WTRU 1321 through AMF 1322, and the response may comeback through AMF 1322 to AUSF 1323.

At 1310, AMF 1322 may send an authentication challenge response to WTRU 1321 (e.g., utilizing the Namf_UEAuthentication_Authenticate response).

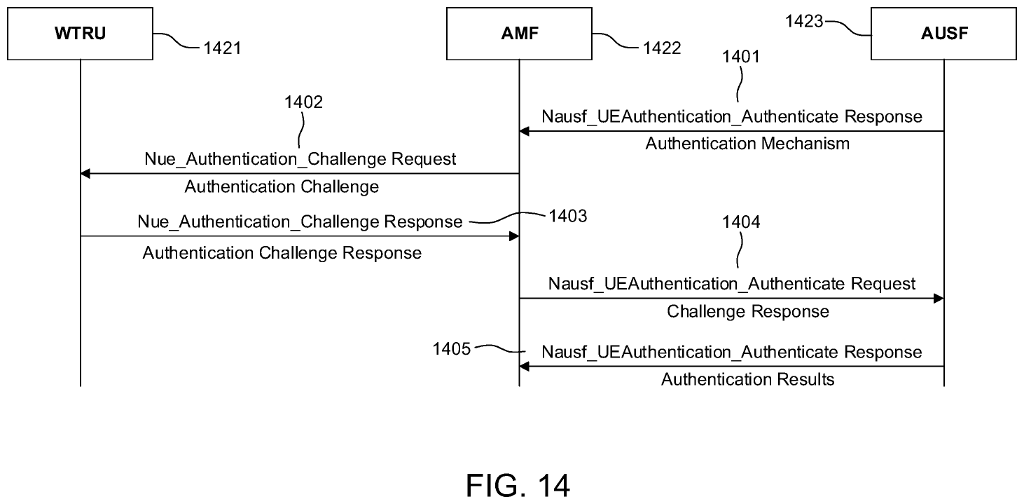

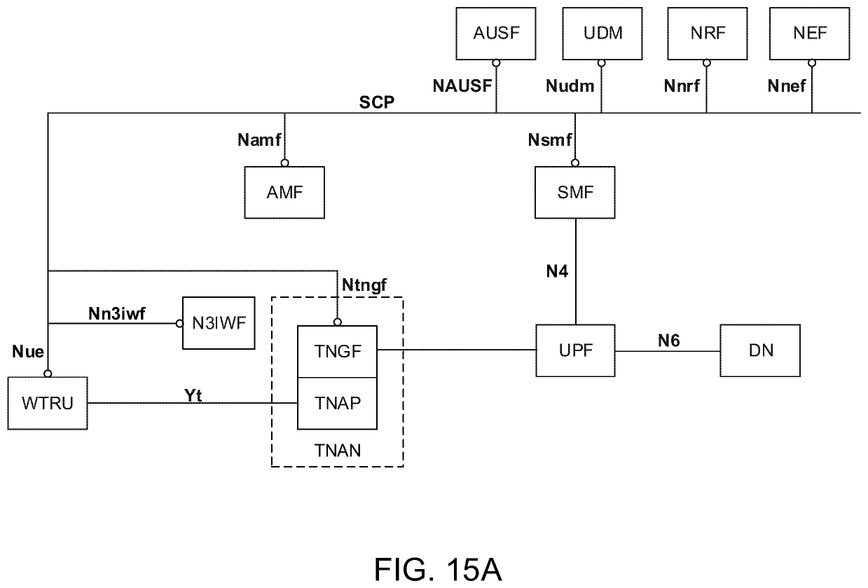

FIG. 14 illustrates an example of a message sequence chart for challenging a WTRU in a 6G NSA system, with a 5G Core Network where only the AMF requires updates on the N1 interface between the WTRU and the AMF. Examples of authentication challenges for WTRUs may be provided herein. As in 5G systems, the CN may (e.g., may further challenge) the WTRU as part of its authentication, as indicated at 1309 of FIG. 13. As shown, there may be WTRU 1421, AMF 1422, and AUSF 1423 (these entities may correspond to those disclosed in FIG. 13, for example).

At 1401, an authentication challenge message may be sent from AUSF 1423 to AMF 1422 (e.g., utilizing a Nausf_UEAuthentication_Authenticate response). The message may include a challenge mechanism and/or an authentication vector, such as (EAP-AKA′ AV [, SUCI]) in the case of EAP-AKA or the (5G HE AV, [SUCI])) in the case of 5G-AKA.

At 1402, AMF 1422 may send the challenge request message to WTRU 1421 (e.g., using a Nue_Authentication_Challenge request). The message may include an EAP Response/AKA′-Challenge/ABBA/ngKSI, or the like in the case of EAP-AKA and a RAND, AUTN, or the like in the case of 5G-AKA.

At 1403, WTRU 1421 may calculate the challenge response and then send a challenge-response message to the AMF 1422 (e.g., utilizing a Nue_Authentication_Challenge response). The message may include an EAP-Response/AKA′-Challenge in the case of EAP-AKA and a RES* in the case of 5G-AKA.

At 1404, AMF 1422 may send a challenge-request message to AUSF 1423 (e.g., Nausf_UEAuthentication_Authenticate Request); this may contain the same or similar information as received from the WTRU 1121.

At 1405, AUSF 1423 may send a challenge-response message to AMF 1422 (e.g., Nausf_UEAuthentication_Authenticate Response); this may contain authentication result information as determined by AUSF 1423.

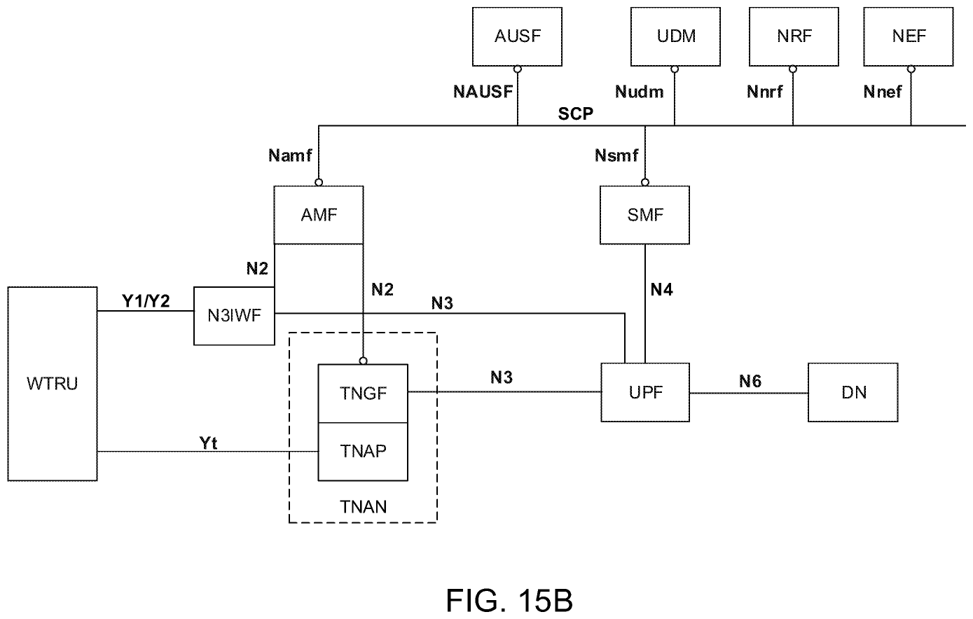

FIG. 15A illustrates an example system authentication architecture and messaging exchange, according to one or more embodiments described herein. Each element of this example system architecture may be optional variations, taken alone or in combination with other approaches, such as FIG. 15B. For example, one or more techniques in the example of FIG. 15A may be combined with the example of FIG. 15B. The AUSF NF may be used as an authentication service provider for trusted and untrusted non-3GPP network, where the AMF role is eliminated in the authentication process. The NRF may act as a token server in this architecture while the UDM, as it does in the 5GC, stores the user subscription data, policy data and application data. The SCP may route traffic from the WTRU, whether in case of trusted or non-trusted networks, to the NF gateway of this network (e.g., N3IWF in case of non-3GPP or TNAN in case of trusted non-3GPP). In this architecture, WTRU and other SBA NFs may have SBIs and act as producers and consumers during the authentication process where the WTRU responds to the different network authentication challenge requests (e.g., the response from the WTRU is sent over HTTP in case of a standalone scenario). In some cases, the Security Anchor Function (SEAF) functionality may be considered as part of the AMF NF.

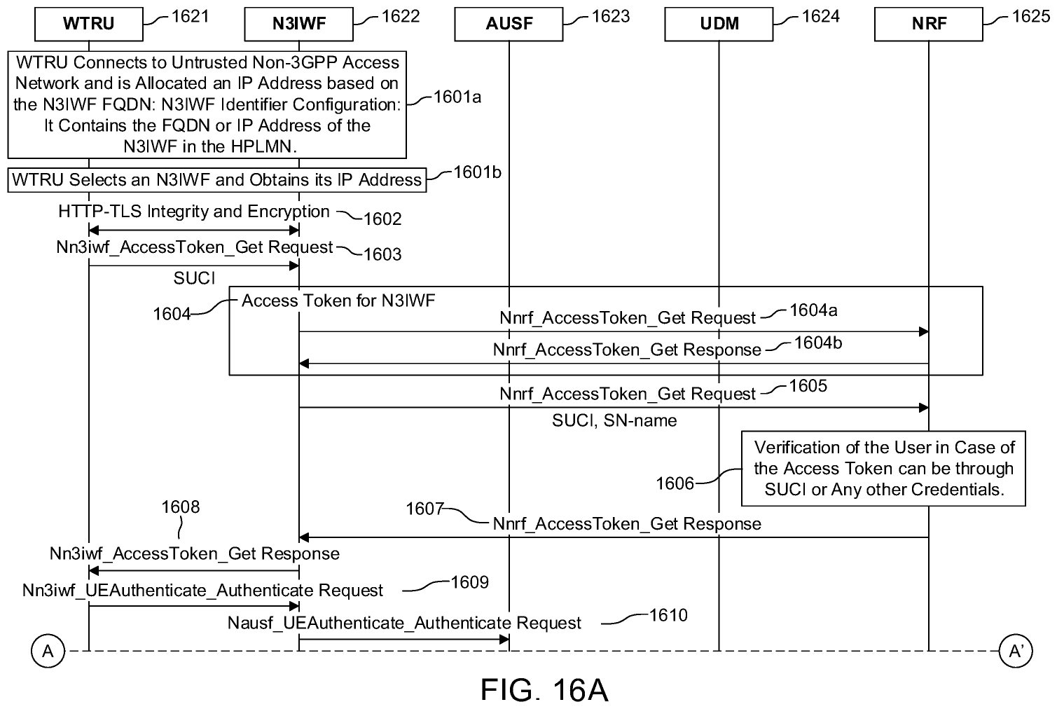

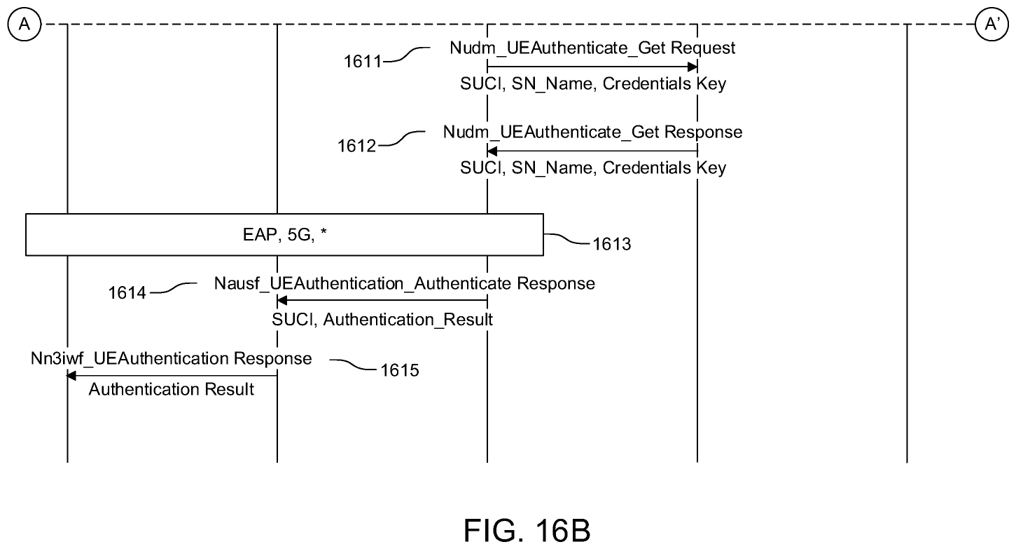

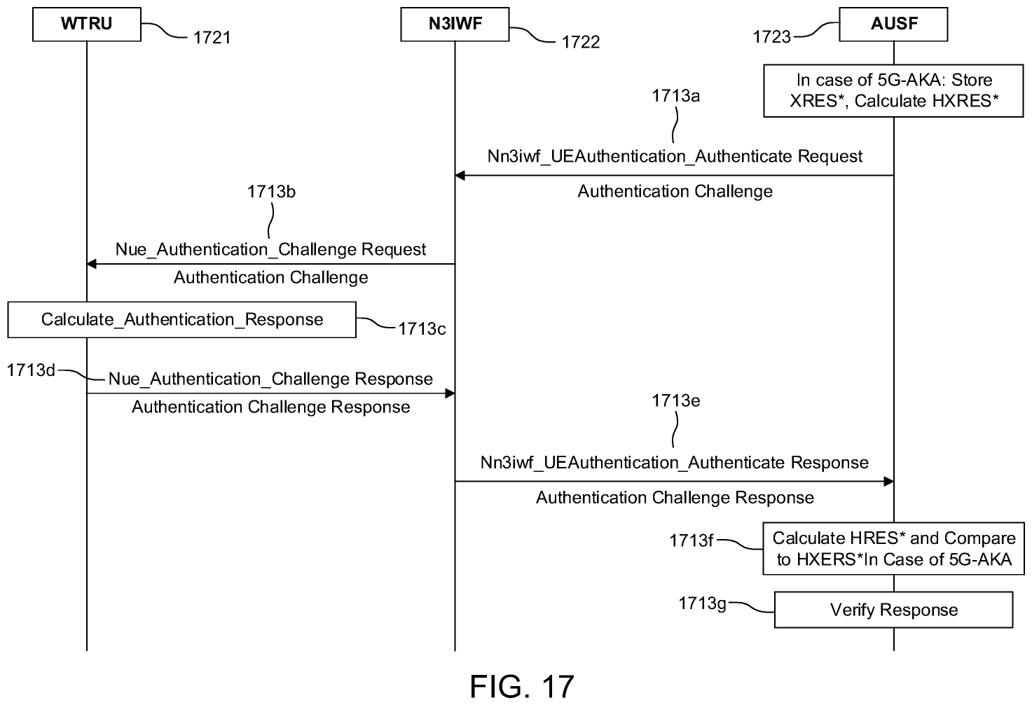

FIG. 16 (FIG. 16A and 16B) illustrates an example of an authentication procedures for untrusted non-3GPP access networks. As shown, there is a WTRU 1621, N3IWF 1622, AUSF 1623, UDM 1624, and an NRF 1625. One or more techniques disclosed herein may be characterized as a sixth generation approach (6G), however, this terminology does not imply incompatibility or any inherently different design with known 5G or 4G techniques unless otherwise stated. For example, there may be an authentication messaging for untrusted non-3GPP access for use between a WTRU and a Core Network (e.g., FIG. 16), and in some instances, this may be characterized as being between a 6G WTRU and a 6G CN. For purposes of this example procedure, the NFs may address each other using an approach unique to end-to-end service-based architecture scenarios. For FIGS. 16 and 17, these may be (e.g., 6G) standalone approaches. Further, any reference to 6G implies 6G or beyond, and is not intended as limiting to only a sixth generation applicability.

FIG. 16 illustrates an example procedure with a series of actions, messages, steps, and/or elements, but this sequence is merely a demonstration and may be taken out of order in cases or may have one or more optional elements. This example has a sequence of messages that provide procedures for WTRUs to retrieve and obtain access to the CN. This example procedure may provide a message flow. At 1601 (1601a and 1601b), WTRU 1621 may be connected to the non-3GPP network and has been allocated an IP address, and WTRU 1621 may select N3IWF 1622 and obtain its IP address.

At 1602, WTRU 1621 may communicate with N3IWF 1622 to establish integrity and encryption in the channel, optionally using TLS.

At 1603, WTRU 1621 may send a request message (e.g., Nn3iwf_Access_Token_Request) to obtain an access token to be able to access CN NFs. The request message may contain the SUCI of WTRU 1621.

At 1604 (1604a and 1604b), to be able to access CN NFs, in case it does not have a valid token from a previous communication, N3IWF 1622 may request an access token from NRF 1625 in 1604a (e.g., utilizing Nnrf_AccessToken_Get Request message). This action may not be needed if N3IWF 1622 has a valid access token.

At 1605, after obtaining an access token at 1604, the access token request from WTRU 1621 may be sent from N3IWF 1622 to NRF 1625. The message may have the SUCI of WTRU 1621.

At 1606, NRF 1625 may verify the user identity. The verification may be done by checking WTRU 1621 SUCI or any other user credentials, with UDM 1624 if needed.

At 1607, the access token may be sent from NRF 1625 to N3IWF 1622 (e.g., utilizing Nnrf_Access_Token_Response).

At 1608, N3IWF 1622 may send the access token to WTRU 1621 (e.g., using Nn3wif_Access_Token_Response message).

At 1609 WTRU 1621 may send an authentication request message (e.g., Nn3iwf_UEAuthenticate_Authenticat Request) to N3IWF 1622. The message may have WTRU 1621 SUCI.

At 1610, N3IWF 1622 may send the authentication message to AUSF 1623 (e.g., utilizing an Nausf_UEAuthenticate_Authenticate Request message).

At 1611, AUSF 1623 may check with UDM 1624 for the WTRU 1621 identity and if WTRU 1621 needs to be authenticated further by sending a request message (e.g., Nudm_UEAuthenticate_Get Request message). The message may have the SUCI or any other credentials related to WTRU 1621.

At 1612, UDM 1624 may respond with a response message (e.g., an Nudm_UEAuthenticate_Get Response message) and informs AUSF 1623 about the user identity verification outcome and checks whether the user needs to be authenticated further. The further authentication may be an optional step and may depend on vendor/operator security considerations and available user profiles.

At 1613, if required by the CN, AUSF 1623 challenges WTRU 1621.

At 1614, the authentication response message (e.g., Nausf_UEAuthentication_Authenticate Response) may be sent from AUSF 1623 to N3IWF 1622. The message may contain the authentication result.

At 1615, the authentication response may be sent back to WTRU 1621 (e.g., with an Nn3iwf_WTRUAuthentication_Authenticate Response). The message may contain the authentication result. If the authentication result is a success, then WTRU 1621 may be authenticated by the CN and may complete the other registration procedures.

FIG. 17 illustrates an example of a message sequence chart for challenging a WTRU in an untrusted non-3GPP network. As shown, there may be a WTRU 1721, a NI3WF 1722, and an AUSF 1723. As in 5G systems, the CN may further challenge WTRU 1721 as part of the authentication process. WTRU 1721 challenge may include series of actions, messages, steps, and/or elements as illustrated in FIG. 17. This may be similar to 1613 of FIG. 16.

At 1713a, a challenge message may be sent from AUSF 1723 to N3IWF 1722. The challenge message may contain any number of indications or parameters such as EAP-AKA′ AV, AKMA indication, Routing indicator, authentication challenge in case of EAP-AKA or RAND, AUTN, AKMA indication, Routing indicator, authentication challenge in case of 5G-AKA. At 1713b, the challenge message may be sent from N3IWF 1722 to WTRU 1721. At 1713c, WTRU 1721 may calculate the authentication challenge response. At 1713d, WTRU 1721 may send the challenge response to N3IWF 1722 which forwards the challenge response to AUSF 1723 at 1713e. The challenge-response message may have an EAP Response/AKA′-Challenge/ABBA/ngKSI in case of EAP-AKA and Response (RES*) in case of 5G-AKA. At 1713g, AUSF 1723 verifies WTRU 1721 challenge response.

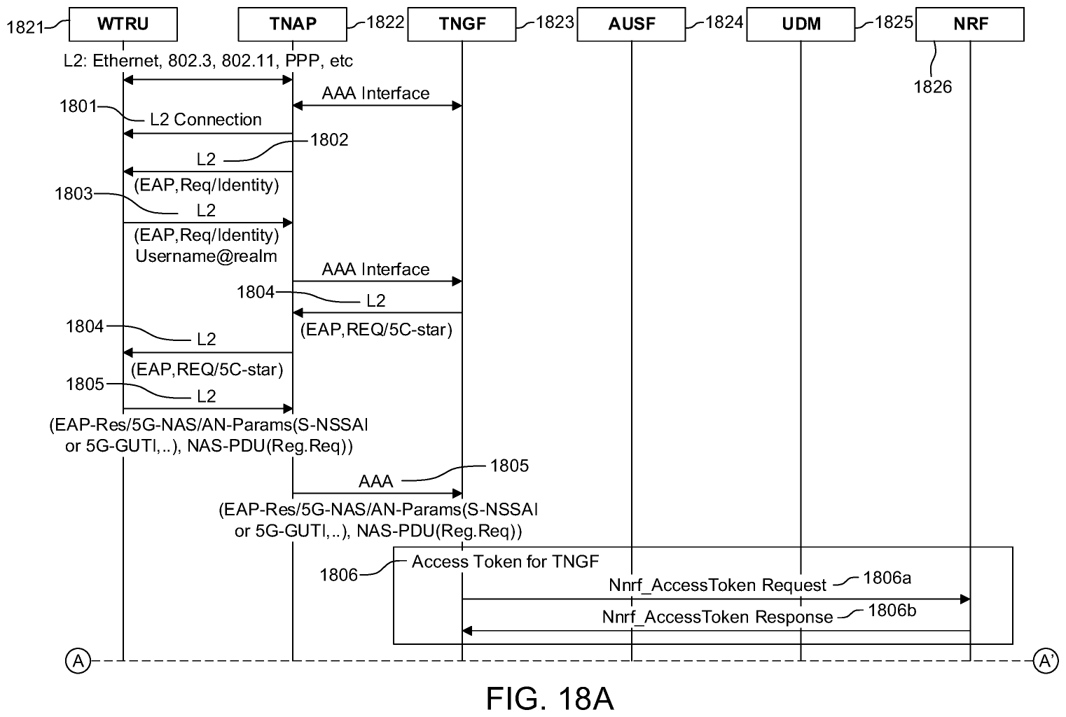

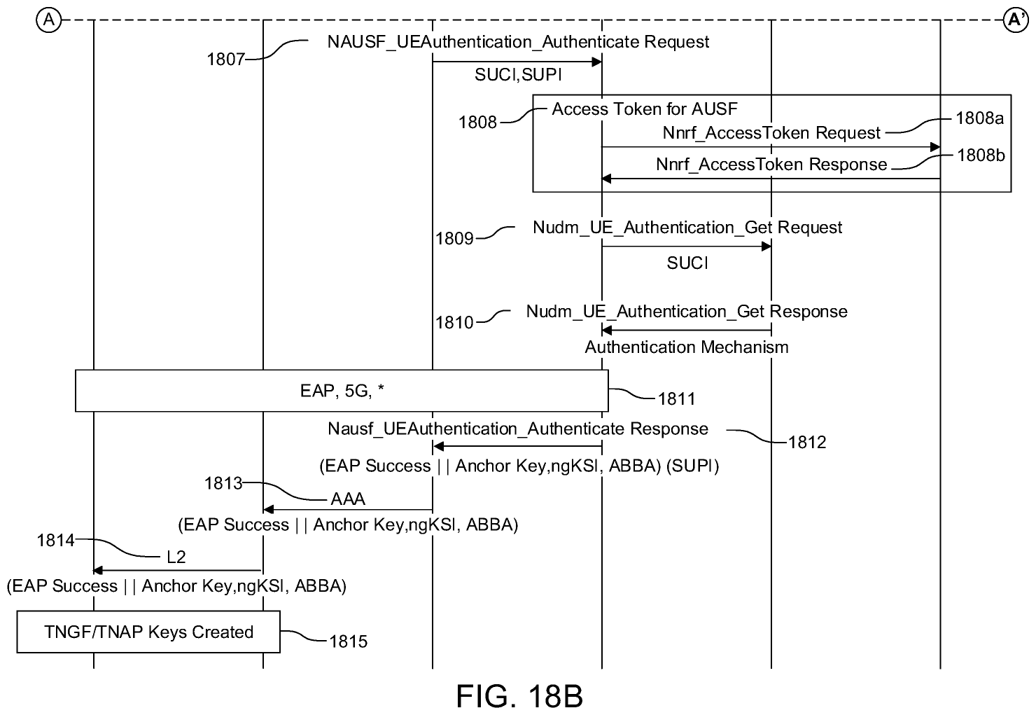

FIG. 18 (FIG. 18A and FIG. 18B) illustrates an example procedure for authentication in trusted non-3GPP access networks. There may be authentication messaging for trusted non-3GPP access for use between a WTRU and a Core Network (e.g., FIG. 9), and in some instances, this may be characterized as being between a 5G WTRU and a 6G CN. For purposes of this example procedure, the NFs may address each other using an approach unique to end-to-end service-based architecture scenarios. For FIGS. 9 and 10, these may be (e.g., 6G) non-standalone approaches.

FIG. 18 illustrates an example procedure with a series of actions, messages, steps, and/or elements, but this sequence is merely a demonstration and may be taken out of order in cases or may have one or more optional elements. This example has a sequence of messages that provide procedures for WTRUs to retrieve and obtain access to the CN. This example procedure may provide a message flow. As shown, there is a WTRU 1821, TNAP 1822, TNGF 1823, AUSF 1824, UDM 1825, and an NRF 1826.

At 1801-1804, WTRU 1821 may communicate with a TNAP to establish integrity and encryption in the channel. It should be noted that encryption between WTRU and TNAP may rely only on L2 encryption as TNAP is a trusted entity and there may be no need for IPsec between WTRU and TNGF.

At 1805, WTRU 1821 may send a request to TNAP 1822 for authentication utilizing AAA (EAP-Res/5G-NAS/AN-Params (S-NSSAI or 5G-GUTI, . . . ],NAS-PDU (Reg.Req) message.

At 1806 (1806a and 1806b), in case it does not have a valid access token, TNGF 1823 may send an access Token request to NRF 1826 to be able to communicate with NFs in the CN at 1806a utilizing Nnrf_AccessToken Request. This may not be required if TNGF 1823 has a valid access token. At 1806b, the access token may be granted by NRF 1826 to TNGF 1823.

At 1807, an authorization message Nausf_UEAuthentication_Authenticate_Request for WTRU 1821 may be sent from TNGF 1823 to AUSF 1824. The message may have the SUCI of WTRU 1821.

At 1808 (1808a and 1808b), in case it does not have a valid access token, AUSF 1824 may request an access token from NRF 1826 at 1808a to be able to communicate with NFs in the CN. This may not be required if AUSF 1824 has a valid access token.

At 1809, after obtaining an access token at 1808b, AUSF may send an authentication request to UDM 1825 utilizing Nudm_UE_Authentication_Get_Request message to check WTRU 1821 identity and whether WTRU 1821 need to be authenticated further. The message may have WTRU 1821 SUCI.

At 1810, UDM 1825 may respond and inform AUSF 1824 if WTRU 1821 needs to be authenticated further. The further authentication may be optional and may depend on the vendor/operator security considerations and available user profiles.

At 1811, if required by the CN, AUSF 1824 may challenge WTRU 1821.

At 1812, the authentication response message, Nausf_UEAuthentication_Authenticate Response, may be sent from AUSF 1824 to TNGF 1823. The Message may comprise the authentication result, SUCI of WTRU 1821, Anchor Key,ngKSI, and/or ABBA.

At 1813, the authentication response may be sent from TNGF 1823 to TNAP 1822 over AAA interface.

At 1814, the authentication response may be sent from TNAP 1822 to WTRU 1821 over L2 medium. If the authentication result is a success, then WTRU 1821 is authenticated by the CN and can complete the other registration procedures. After the successful authentication, WTRU creates TNGF/TNAP keys as shown at 1815.

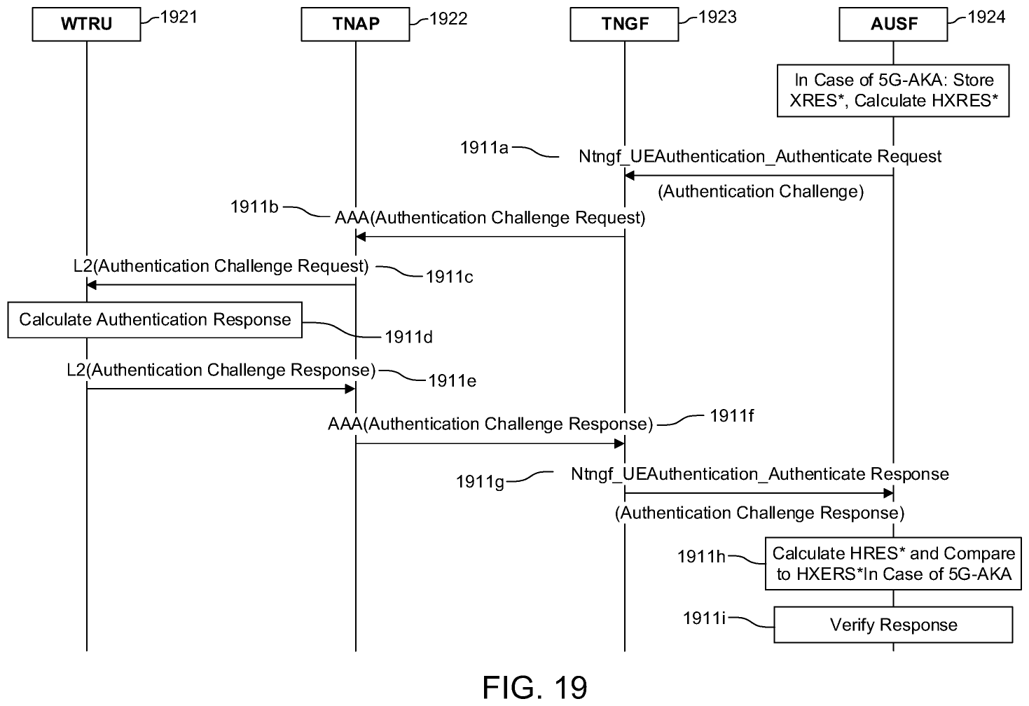

FIG. 19 illustrates an example of a message sequence chart for challenging a WTRU in a trusted non-3GPP network. As in 5G systems, the CN may further challenge WTRU 1921 as part of the authentication process, as indicated 1811 of FIG. 18. The challenge illustrated is an example procedure with a series of actions, messages, steps, and/or elements, but this sequence is merely a demonstration and may be taken out of order in cases or may have one or more optional elements.

At 1911a, an authentication challenge message may be sent from AUSF 1924 to TNGF 1923. The challenge message may comprise one or more indications and/or parameters, such as EAP-AKA′ AV, AKMA indication, Routing indicator, authentication challenge in case of EAP-AKA or 5G HE AV, AKMA indication, Routing indicator, authentication challenge in case of 5G-AKA.

At 1911b, the challenge message may be sent from TNGF 1923 to TNAP 1922 over AAA interface with the same content as in a previous action.

At 1911c, the challenge message may be sent from TNAP 1922 to WTRU 1921 over L2 medium with the same content as in a previous action.

At 1911d, WTRU 1921 may calculate the authentication challenge response.

At 1911e, WTRU 1921 may send the challenge response to TNAP 1922 which forwards the challenge response to TNGF 1923 at 1911f. The challenge-response message may have EAP Response/AKA′-Challenge/ABBA/ngKSI in case of EAP-AKA and Response (*RES) in case of 5G-AKA.

At 1911g, TNGF 1923 may send the challenge response to AUSF 1924.

At 1911i, AUSF 1924 may verify WTRU 1921 challenge response.

In one or more embodiments, there may be a method that enables direct communication between a WTRU and Core Network Functions in non-3GPP Access Networks for Authentication purposes. This method for authentication may use a WTRU with SBI interface, which acts as a producer and consumer over HTTP, like other parts of the SBA NFs. This method may allow for many benefits, such as unification in authentication methods and procedures for trusted and untrusted non-3GPP networks.

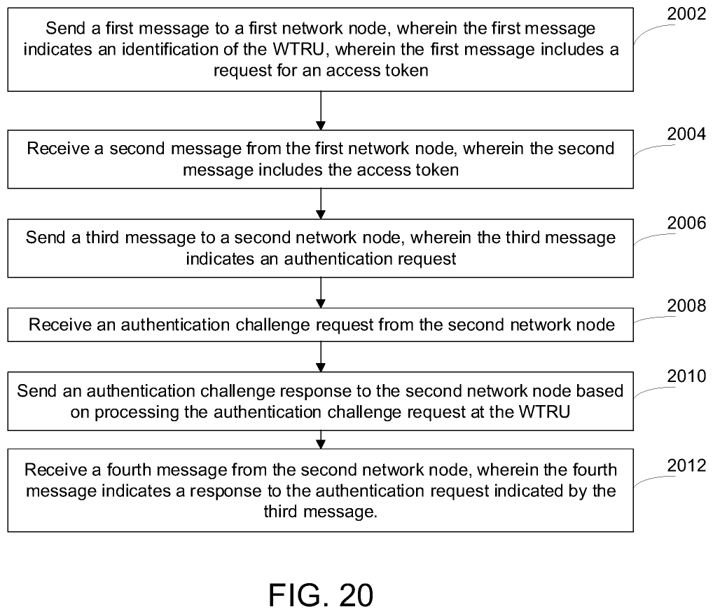

FIG. 20 illustrates an example of an authentication process performed by a WTRU. The WTRU at 2002 may send a first message to a first network node. The first message may indicate an identification of the WTRU. The first message may include a request for an access token. At 2004, the WTRU may receive a second message from the first network node. The second message may include the access token. At 2006, the WTRU may send a third message to a second network node. The third message may indicate an authentication request. At 2008, the WTRU may receive an authentication challenge request from the second network node. At 1010, the WTRU may send an authentication challenge response to the second network node based on processing the authentication challenge request at the WTRU. At 2012, the WTRU may receive a fourth message from the second network node. The fourth message may indicate a response to the authentication request indicated by the third message. In some instances, the first network node is a Network Repository Function (NRF). In some instances, the second network node is an Authentication Server Function (AUSF). In some instances, the response to the authentication request indicates that the WTRU is authenticated. In some instances, the WTRU may send a secure transmission based on receiving the authentication challenge response. In some instances, the authentication challenge is processed using (Extended Authentication Protocol) EAP or Authentication and Key Agreement (AKA). In some instances, the identification of the WTRU is a Subscription Concealed Identifier (SUCI). In some instances, all communication from the WTRU to the first node and the second node may be encrypted using Transport Layer Security (TLS) encryption; and/or, initially, the WTRU may establish TLS encryption with the first node and the second node.

As described herein, a higher layer may refer to one or more layers in a protocol stack, or a specific sublayer within the protocol stack. The protocol stack may comprise of one or more layers in a WTRU or a network node (e.g., eNB, gNB, other functional entity, etc.), where each layer may have one or more sublayers. Each layer/sublayer may be responsible for one or more functions. Each layer/sublayer may communicate with one or more of the other layers/sublayers, directly or indirectly. In some cases, these layers may be numbered, such as Layer 1, Layer 2, and Layer 3. For example, Layer 3 may comprise of one or more of the following: Non-Access Stratum (NAS), Internet Protocol (IP), and/or Radio Resource Control (RRC). For example, Layer 2 may comprise of one or more of the following: Packet Data Convergence Control (PDCP), Radio Link Control (RLC), and/or Medium Access Control (MAC). For example, Layer 3 may comprise of physical (PHY) layer type operations. The greater the number of the layer, the higher it is relative to other layers (e.g., Layer 3 is higher than Layer 1). In some cases, the aforementioned examples may be called layers/sublayers themselves irrespective of layer number, and may be referred to as a higher layer as described herein. For example, from highest to lowest, a higher layer may refer to one or more of the following layers/sublayers: a NAS layer, a RRC layer, a PDCP layer, a RLC layer, a MAC layer, and/or a PHY layer. Any reference herein to a higher layer in conjunction with a process, device, or system will refer to a layer that is higher than the layer of the process, device, or system. In some cases, reference to a higher layer herein may refer to a function or operation performed by one or more layers described herein. In some cases, reference to a high layer herein may refer to information that is sent or received by one or more layers described herein. In some cases, reference to a higher layer herein may refer to a configuration that is sent and/or received by one or more layers described herein.

While some techniques are disclosed as a series of steps (e.g., embodiments, methods, procedures, examples, etc.), one of ordinary skill in the art will appreciate that each of these steps for each example may be optional, and further can be used alone or in any combination with other techniques disclosed herein. For example, an example procedure may be disclosed herein with regard to a figure for illustrative purposes, and one of ordinary skill in the art will appreciate that one or more steps from this procedure may be used alone or in combination with one or more steps from a procedure of another example figure.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method for a wireless transmit receive unit (WTRU), the method comprising:
sending a first message to a first network node, wherein the first message indicates an identification of the WTRU, and wherein the first message includes a request for an access token;
receiving a second message from the first network node, wherein the second message includes the access token;
sending a third message to a second network node, wherein the third message indicates an authentication request that includes the access token obtained from the second message;
receiving an authentication challenge request from the second network node;
sending an authentication challenge response to the second network node based on processing the authentication challenge request at the WTRU; and
receiving a fourth message from the second network node, wherein the fourth message indicates a response to the authentication request indicated by the third message.

2. The method of claim 1, wherein the first network node is a Network Repository Function (NRF).

3. The method of claim 1 or 2, wherein the second network node is an Authentication Server Function (AUSF).

4. The method of any one of claims 1 to 3, wherein the response to the authentication request indicates that the WTRU is authenticated.

5. The method of any one of claims 1 to 4, further comprising:
prior to sending the first message, establishing Transport Layer Security (TLS) encryption with the first network node and the second network node; and
sending a secure transmission based on receiving the authentication challenge response.

6. The method of any one of claims 1 to 5, wherein the authentication challenge is processed using (Extended Authentication Protocol) EAP or Authentication and Key Agreement (AKA).

7. The method of any one of claims 1 to 6, wherein the identification of the WTRU is a Subscription Concealed Identifier (SUCI).

8. A wireless transmit receive unit (WTRU), the WTRU comprising:
a processor operatively connected to a transceiver,
the processor and transceiver configured to send a first message to a first network node, wherein the first message indicates an identification of the WTRU, and wherein the first message includes a request for an access token;
the processor and transceiver configured to receive a second message from the first network node, wherein the second message includes the access token;
the processor and transceiver configured to send a third message to a second network node, wherein the third message indicates an authentication request that includes the access token obtained from the second message;
the processor and transceiver configured to receive an authentication challenge request from the second network node;
the processor and transceiver configured to send an authentication challenge response to the second network node based on processing the authentication challenge request at the WTRU; and
the processor and transceiver configured to receive a fourth message from the second network node, wherein the fourth message indicates a response to the authentication request indicated by the third message.

9. The WTRU of claim 8, wherein the first network node is a Network Repository Function (NRF).

10. The WTRU of claim 8, wherein the second network node is an Authentication Server Function (AUSF).

11. The WTRU of claim 8, wherein the response to the authentication request indicates that the WTRU is authenticated.

12. The WTRU of claim 8, wherein,
prior to sending the first message, the processor and transceiver configured to send establish Transport Layer Security (TLS) encryption with the first network node and the second network node; and
the processor and transceiver configured to send a secure transmission based on receiving the authentication challenge response.

13. The WTRU of claim 8, wherein the authentication challenge is processed using (Extended Authentication Protocol) EAP or Authentication and Key Agreement (AKA).

14. The WTRU of claim 8, wherein the identification of the WTRU is a Subscription Concealed Identifier (SUCI).

15. A method for a network node, the method comprising:
receiving a first message from a wireless transmit-receive unit (WTRU), wherein the first message indicates an authentication request;
sending an authentication challenge request to the WTRU;
receiving an authentication challenge response from the WTRU; and
sending a second message to the WTRU, wherein the second message indicates a response to the authentication request indicated by the first message.

16. The method of claim 15, wherein the network node is an Authentication Server Function (AUSF).
